(19) United States
(12) Patent Application Publication
(10) Pub. No.: US 2012/0322380 A1
(43) Pub. Date: Dec. 20, 2012

(54) LOCALIZED TRACKING OF ITEMS WITH ELECTRONIC LABELS

(76) Inventors: Owen Nannarone, Scituate, MA (US); Len Nannarone, Scituate, MA (US); Marcus Edward Wilson, Natick, MA (US); Timothy H. Linberg, West Roxbury, MA (US)

(21) Appl. No.: 13/412,052

(22) Filed: Mar. 5, 2012

Related U.S. Application Data
(60) Provisional application No. 61/497,874, filed on Jun. 16, 2011.

(51) Int. Cl. H04B 7/00; H04B 17/00

(52) U.S. Cl. 455/41.2; 455/67.11

(57) ABSTRACT

In one aspect, the present disclosure describes a method that may include identifying, by a monitoring device, a transmission signal of an electronic label, where the monitoring device includes an antenna and a processor. The method may include determining a distance for monitoring the transmission signal of the electronic label, and calibrating a transmission strength for communication with the electronic label via the transmission signal, where the transmission strength is calibrated to approximately achieve the distance. The method may include configuring a communication link between the antenna and the electronic label at approximately the transmission strength, monitoring availability of the communication link, identifying a loss of connection with the communication link, and responsive to the loss of connection, causing, by the monitoring device, an alert to be issued.

### RELATED APPLICATIONS

The present application claims priority to U.S. Provisional Application No. 61/497,874 entitled “Systems and Methods for the Localized Tracking of Credit Cards” and filed Jun. 16, 2011, the contents of which are hereby incorporated by reference in their entirety.

### BACKGROUND

Short range communications may be used to recognize items or retrieve information from items including electronic labels or electronic tags. In some examples, a radio frequency (RF) signal, Bluetooth®, Near field communication (NFC), or Wi-Fi™ based wireless connection may be established between an electronic label and a label reading device. Short range communications standards such as, in some examples, ISO/IEC 14442, ISO/IEC 18092, or FeliCa may be used in some circumstances to communicate information from an electronic label to a label reading device.

### SUMMARY

In one aspect, the present disclosure describes a method that may include identifying, by a monitoring device, a transmission signal of an electronic label, where the monitoring device includes an antenna and a processor. The method may include determining a distance for monitoring the transmission signal of the electronic label, and calibrating a transmission strength for communication with the electronic label via the transmission signal, where the transmission strength is calibrated to approximately achieve the distance. The method may include configuring a communication link between the antenna and the electronic label at approximately the transmission strength, monitoring availability of the communication link, identifying a loss of connection with the communication link, and responsive to the loss of connection, causing, by the monitoring device, an alert to be issued.

The transmission signal may include a short-range transmission signal. The alert may be issued by the monitoring device. Calibrating the transmission strength may include energizing the electronic label, through the antenna, at a first energy level.

The method may include storing, on a memory, information associated with the electronic label. The information may include signal-identifying information. The information may include a name associated with the electronic label. The information may include the distance.

The monitoring device may include the memory. The monitoring device may be configured to access the memory via a network connection. Configuring the communication link may include invoking a security mechanism.

The electronic label may include a radio frequency (RF) antenna. The RF antenna may be designed to modulate an interrogating signal of the monitoring device to produce a backscatter signal.

In one aspect, the present disclosure describes an apparatus including an antenna, a processor, and memory, the memory storing instructions that, when executed, cause the processor to: determine a transmission strength for communication with an electronic label at least up to a range, establish a communication signal with the electronic label, monitor availability of a transmission from the electronic label, and identify a failure to detect the transmission.

The instructions further cause the processor to, prior to establishing the communication signal, energize, by the antenna, a passive transmitter of the electronic label, and the transmission may be a reflected transmission of an interrogating signal emitted from the antenna. The instructions may further cause the processor to trigger an alert mechanism responsive to identification of the failure. The alert mechanism may include triggering an audible alarm through a speaker.

The instructions may further cause the processor to store, in a second memory, information associated with the electronic label. The memory may include the second memory.

The instructions may further cause the processor to, upon re-establishment of power following a power loss: access a portion of the information, where the portion is useful for detection of the reflected transmission, identify availability of the reflected transmission, and return to monitoring availability of the reflected transmission.

The instructions may further cause the processor to authenticate the electronic label prior to monitoring availability of the reflected transmission. Authenticating the electronic label may include reading an electronically-readable code on the electronic label, and the instructions may further cause the processor to compare data derived from the electronically-readable code to authentication data stored in the memory.

In one aspect, the present disclosure describes a non-transitory computer readable medium, where the computer readable medium stores instructions that, when executed by a processor, cause the processor to: receive a pairing request via a user interface, and determine an energy level correlating to a range of transmission. The energy level, when applied to a passive radio frequency tag, may be configured to enable the passive radio frequency tag to reflect an interrogating signal from a monitoring antenna as a reflected signal. The reflected signal may be configured to be detectable by the monitoring antenna up to and including the range of transmission. The instructions may further cause the processor to energize the passive radio frequency tag at approximately the determined energy level, and monitor availability of the reflected signal.

The instructions may further cause the processor to receive the range of transmission via the user interface. The instructions may further cause the processor to trigger an alert mechanism responsive to loss of availability of the reflected signal.

The instructions may further cause the processor to: receive a tracking request via the user interface, and estimate a distance between the monitoring antenna and the passive radio frequency tag. The instructions may further cause the processor to: receive a tracking request via the user interface, and estimate a direction of the passive radio frequency tag from the monitoring antenna.

In one aspect, the present disclosure describes an electronic label including an adhesive portion for securing the electronic label to an item, an antenna for short range communication with an interrogating device, and a modulator configured for passive communication between the antenna and the interrogating device. The modulator may modulate an interrogating signal from the interrogating device to produce a backscatter signal. The modulator may be designed to produce the backscatter signal up to a maximum frequency of at least approximately 1.5 GHz.

The electronic label may include a security mechanism, where the security mechanism is configured to allow the interrogating device to recognize the electronic label as an authorized electronic label. The security mechanism may include a surface design including an electronically-readable code. The security mechanism may include a unique identifier transmitted in the backscatter signal. The security mechanism may include a frequency-shift key encoding.

The antenna may be a radio frequency antenna. The maximum frequency may be at least approximately 2.5 GHz. The maximum frequency may be at least approximately 4 GHz.

The backscatter signal may be configurable for detection within a range of at least sixty feet. The backscatter signal may be configurable for detection within a range of at least one hundred feet. The backscatter signal may be configurable for detection within a range of at least two hundred feet.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIGS. 1A through 1D illustrate example systems for tracking items with electronic labels;

FIG. 2 illustrates examples of electronic labels;

FIGS. 3A through 3D illustrate a situation involving monitoring a signal from an electronic label;

FIGS. 4A through 4D illustrate a series of example user interfaces for configuring an application for tracking items with electronic labels;

FIGS. 5A and 5B illustrate a series of example user interfaces for an application for tracking items with electronic labels;

FIGS. 6A and 6B are a flow chart of an example method for tracking items with electronic labels;

FIG. 7 is a block diagram of an example network environment for tracking items with electronic labels;

FIG. 8 is a block diagram of a computing device and a mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

In some implementations, a device including a short range communications antenna and support (e.g., radio frequency or other near field communication (NFC) protocols, Wi-Fi™, Bluetooth®, etc.) may be used to initiate communication with one or more electronic labels. In some implementations, the device may be used to initiate communication with one or more electronic labels using infrared technology or microwaves.

The electronic labels, in some implementations, may include passive mode communication devices (e.g., lacking a local power source) such as a passive radio transponder or a passive radio-frequency identification (RFID) tag. In other implementations, the electronic labels may include semi-passive or active mode communication devices, such as a battery powered or battery backed up RFID tag, or a Wi-Fi™ or Bluetooth® transponder. In some examples, electronic labels including active mode communication devices may include twisted antenna coils, laser embedded technology, or other micro active tag technology.

The electronic labels, in some implementations, may each be built into an item. In some examples, items containing electronic labels may include credit cards, identification cards or documents (e.g., passport, driver's license, employee badge, etc.), specialized payment cards or passes (e.g., public transportation pass, toll payment transponder, etc.), personal electronics devices (e.g., a smart phone, handheld multimedia entertainment device, personal digital assistant, tablet computer, notebook computer, laptop computer, electronic gaming console, or desktop computer, etc.), or consumer product items (e.g., stitched into apparel items, included in a bar code or identifying region of a consumer product, etc.). In some implementations, electronic labels may be built into or applied onto the packaging of an item. In some examples, shipping containers may include an electronic label, or shipping labels (e.g., adhesive labels), SKU bar code tags, or other adhesive “stickers” may include electronic labels. In some implementations, items containing electronic labels may include personal items for use in tracking individuals, such as, in some examples, pieces of jewelry or prisoner tracking devices (e.g., “ankle bracelet”). An electronic label, in some implementations, may be embedded in a living being; for example, a biomarker may be embedded in, e.g., humans, pets or livestock for identification purposes. In some implementations, an electronic label may be built into or applied to a personal mode of transportation such as, in some examples, a bicycle, car, motorcycle, or electric scooter.

The device, in some implementations, may include a portable computing device such as, in some examples, a smart phone, handheld multimedia entertainment device, personal digital assistant, tablet computer, notebook computer, or laptop computer. In some implementations, the device may include a stationary-deployed device (e.g., with respect to the electronic labels) such as, in some examples, a set top box, home multimedia control unit, home security control unit, small business/deployment security control unit, a wireless or wired communications hub, a communications/multimedia control unit built into a personal or commercial vehicle, or a container vessel security master unit.

The device, in some implementations, may be designed with the purpose of localized tracking of items with electronic labels. For example, the device may include built in functionality including one or more of software, firmware, and hardware, which may be used to initiate communications with and consequently track one or more items including electronic labels. In some implementations, a user may install one or more software applications and/or access one or more software algorithms available in a remote storage location (e.g., network cloud) to perform localized tracking of items with electronic labels using a general purpose computing device.

The range of the short range communications between the device and the electronic labels, in some implementations, may equate to an estimated geographic area (e.g., an approximate radius surrounding the device). The actual communications range, or geographic area, may be effected by a number of factors including, but not limited to, physical (e.g., blocking line of sight) impediments, material (e.g., communications-disrupting) impediments, interference from other communications within the short range area, and manufacturing design choices and/or manufacturing defects within an individual electronic label or antenna structure of a particular device. In some implementations, the device may establish an estimated range for communications (e.g., within six feet, ten feet, twenty feet, sixty feet, or one hundred feet, etc.) through supplying a particular energy level to a passive electronic label. The geographic area, in some implementations, may be selected by a user through a user interface. In one example, the geographic range may include a radius varying from approximately seventeen centimeters to approximately one hundred feet.

Upon exceeding the range of the short range communications established between the device and one of the electronic labels, in some implementations, the device may issue an alert. In some examples, the alert may include one or more device-resident alert mechanisms such as an audible alert (e.g., alarm or ring tone, etc.), a visual alert (e.g., displayed message, flashing light, etc.) and a tactile alert (e.g., vibration). Additionally or alternatively, the device may issue a remote alert mechanism such as a text message, email, or other communication such as the trigger of an external alert mechanism (e.g., issue a command to a home security system, trigger a response in a store security system, issue information to the 9-1-1-system, communicate with police, fire, security, medical professional, etc.).

The electronic labels, in some implementations, may include an RFID tag. An RFID tag, in some implementations, may include an integrated circuit for storing and processing information, modulating and demodulating an RF signal, and other specialized functions. In other implementations, a “chipless” RFID tag may provide a method for discrete identification without the use of an integrated circuit.

An RFID tag, in some implementations, may include an antenna for receiving and transmitting an RF signal. In some examples, an RFID tag may include an RF transmitter including a built in power supply (e.g., battery, etc.) to provide operating power. In other examples, an RFID tag may be “field powered”, obtaining operating power by rectifying an interrogating RF signal. The range of a battery-powered RFID tag, in some implementations, may be limited in part upon a signal to noise level of the communications link. In a particular example, a batter-powered RFID tag may be capable of being modulated to create a range of communications link from a few centimeters up to approximately 100 feet. The range of a passive RFID tag, in contrast, may in some implementations be limited by the amount of radiated power supplied via an interrogating signal. In a particular example, typical passive RFID tags may be designed for communication distances from about ten centimeters to about three meters.

In some implementations, the electronic labels may include either passive RFID tags employing backscatter radiation or semi-passive (e.g., battery backed up) RFID tags employing backscatter radiation to increase a communications range of the electronic label. For example, an RFID tag may be manufactured to employ backscatter radiation to save energy during transmission by switching the impedance of the antenna to reflect or absorb electromagnetic energy in synchronization with the interrogating stream. In some implementations, a load on the antenna of the RFID tag may work to modulate a transmission signal from an interrogating device. The use of backscatter radiation for increasing communication range may be based upon Faraday's Law which states that a time-varying magnetic field through a surface bounded by a closed path induces a voltage around the loop. Consequently, backscatter radiation may be considered to be radiation that deflects off of a target at an angle of deflection greater than 90°. The radiated wave created by an interrogating device and induced on the passive RFID tag, in some implementations, may be returned to the interrogating device where it will induce a voltage and thus produce a detectable signal. This signal may be referred to as a backscattered signal.

In some implementations, the communication range may be based in part upon an amount of power delivered to the RFID tag. For example, the amount of power allocated for delivery to the RFID tag from the interrogating device to establish a wireless communication link with a particular range may be referred to as a forward link budget. The amount of power supplied in response from the RFID tag may be referred to as a reverse link budget. In the circumstance of an active or semi-passive RFID tag, in some implementations, the reverse link budget may be adjusted in part through a power supply built into the RFID tag. In the circumstance of a passive RFID tag, the reverse link budget may be derived from the forward link budget based in part, in some implementations, upon manufacturing features of the passive RFID tag.

In some implementations, a passive RFID tag with backscatter radiation may be designed for a maximum communication range of approximately one hundred feet, two hundred feet, or one thousand feet. The maximum range, in some implementations, may depend in part upon a size of the printed tag. For example, to track containers on a large container vessel, RFID footprints may be designed at a square foot area or greater to increase transmission range. From the maximum communication range, in some implementations, an established communication range may be determined in part upon a forward link budget and/or reverse link budget. For example, a ratio of an amount of power (e.g., up to a maximum correlating to the maximum communication range), in some implementations, may be determined to establish a communication link corresponding to an estimation of a particular signal range.

In some implementations, during transmission, an interrogating device may select an energy level to increase transmission range (e.g., read range) by taking advantage of the power gain capabilities of the RFID tag with backscatter radiation. In other words, although RFID tags may typically be designed for use in the radio frequency band at approximately 862 MHz to 928 MHz, a frequency of transmission between the RFID tag and the interrogating device may be increased beyond typical RFID tag range by taking advantage of the behavior of the backscatter radiation. The transmission frequency, in some implementations, may be increased to a frequency range similar to the Bluetooth® frequency range, in other words within the 2.5 GHz Industrial, Scientific, and Medical (ISM) frequency band. In a particular example, a frequency of approximately 2.4 GHz may equate to a geographic range of approximately sixty feet, while a frequency of approximately 5 GHz may equate to a geographic range of approximately three hundred feet.

In some implementations, the electronic labels may include either passive RFID tags or semi-passive RFID tags which are provided with an alternating current (AC) signal. The AC signal, for example, may provide varying degrees of voltage to establish an antenna impedance corresponding to a reverse link budget adequate to establish an approximate communication range. In some implementations, the RFID tag may contain a DC regulator to expand a transmission range.

The electronic labels, in some implementations, may be configured to receive microwave signals. Energy supplied from an interrogating device via the microwave signal, in some implementations, may generate an antenna impedance corresponding to a reverse link budget with an approximated transmission range. In some implementations, a passive RFID tag may be manufactured to receive microwave transmissions.

In some implementations, the electronic labels may include semi-passive RFID tags including a fluid-activated battery element. For example, upon submersion, the fluid-activated battery element may be activated to stimulate an expanded transmission range. The expanded transmission range, in some implementations, may vary up to and including approximately one hundred feet. The expanded transmission range, for example, may correlate to a range adequate for alerting a parent of the submersion of an electronic label attached to a child. The parent, in response, may locate the child to avoid potential drowning.

In some implementations, the electronic label may include one or more features designed to enhance the security of transmission between the electronic label and the monitoring device. In one example, the electronic label may be embedded with one or more encryption features, e.g., an encryption mechanism, such that the monitoring device and the electronic label communicate through an encrypted transmission. In another example, the electronic label may be embedded with a unique identifier that may be included within transmission (e.g., in a packet header). A tracking application executing on the monitoring device, further to this example, may be designed to recognize a particular series or type of identification string. Security mechanisms such as those described above may be used, in some implementations, to avoid spoofing an electronic label or to deter manufacture of third party labels for use with a tracking application executing upon the monitoring device.

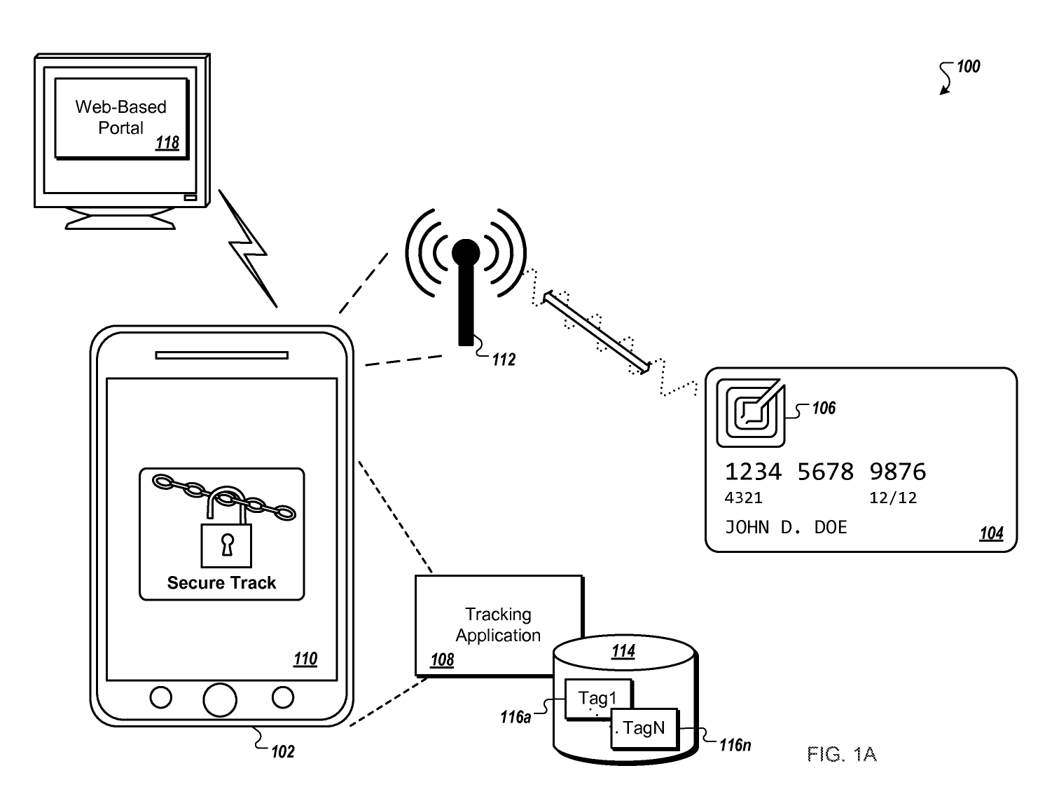

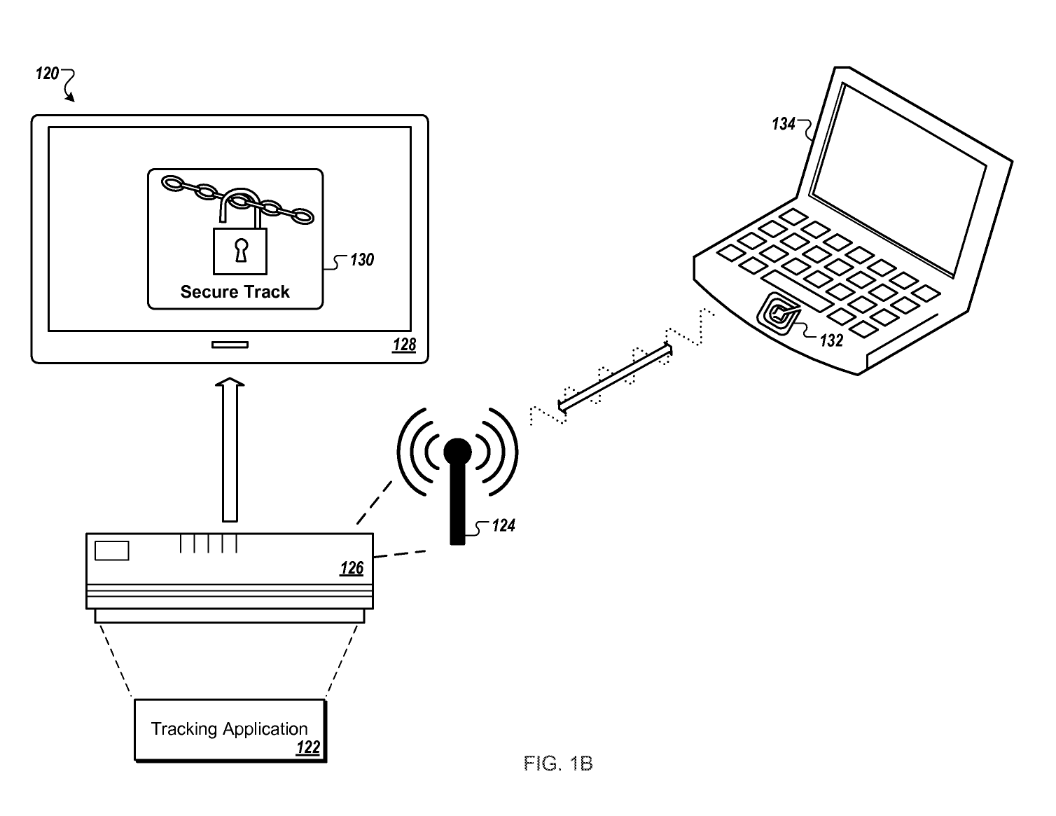

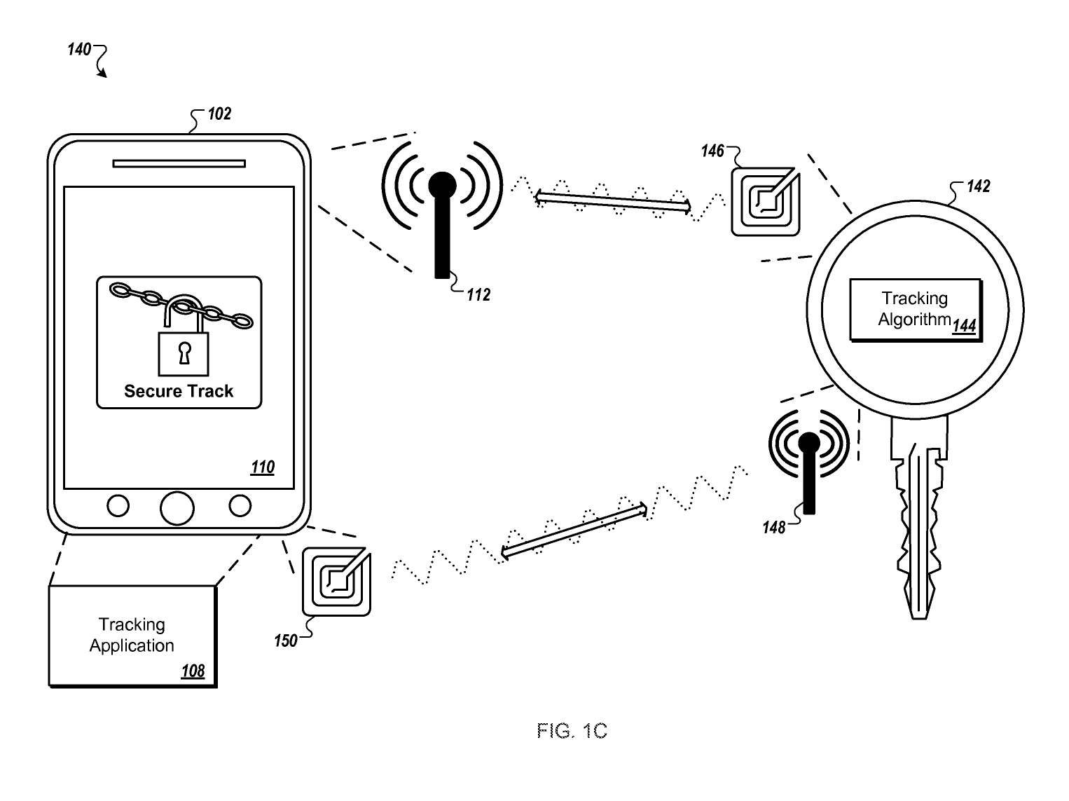

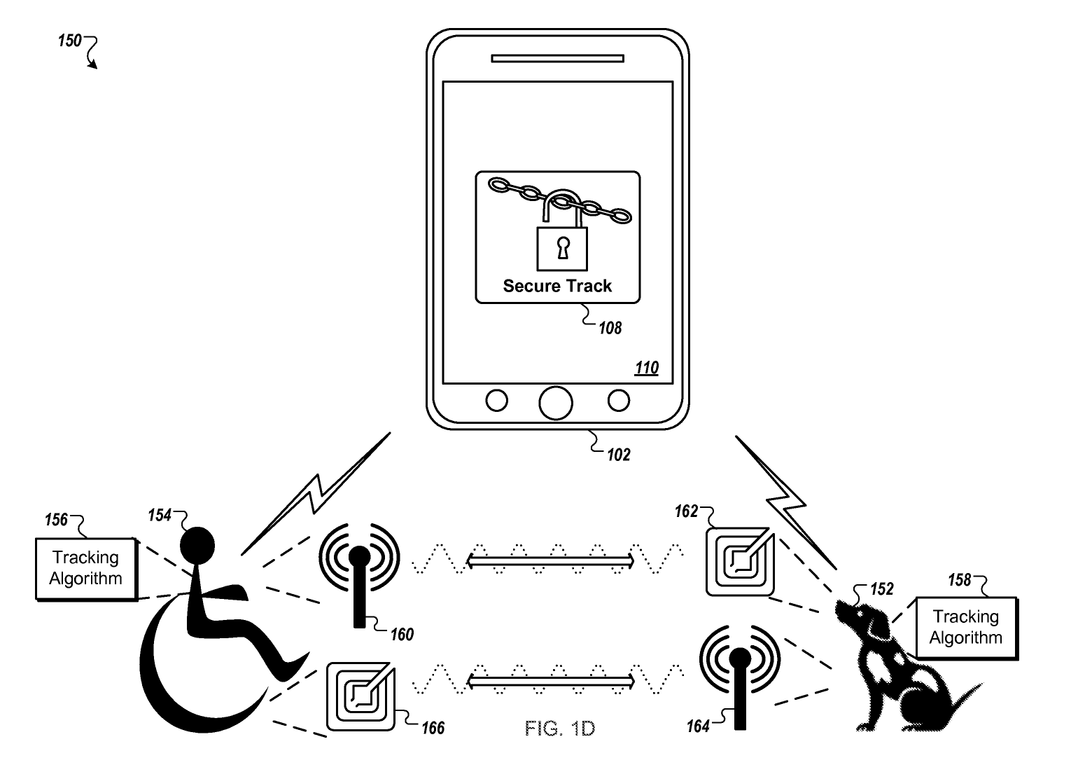

FIGS. 1A through 1D illustrate various systems for localized tracking of items with electronic labels. Turning now to FIG. 1A, in some implementations, an example system 100 for tracking items with electronic labels may include an interrogating device 102 and one or more tracked items each including a respective electronic label, such as a credit card 104 with electronic label 106. The interrogating device 102, as illustrated, may be a portable electronic device such as, in some examples, a smart phone, handheld multimedia entertainment device, personal digital assistant, or tablet computer. The interrogating device 102, in some implementations, may execute a tracking application 108 (e.g., “Secure Track”, as illustrated in a display 110 of the interrogating device 102). The tracking application 108, in some implementations, may control an antenna 112 (e.g., an internal or external antenna for operation in a short range communication frequency band) to interrogate the electronic label 106. The electronic label 106, in some examples, may be built into the credit card 104 or applied to the credit card 104 (e.g., as a printed electronic label, for example applied during credit card manufacture or printed onto the credit card by the lending institution, or an adhesive electronic label applied by the owner of the credit card or by the lending institution, etc.). In a particular example, an adhesive electronic label (e.g., a “sticker”) may be purchased by a user and applied to an item for use in tracking the item via the tracking application 108.

In some implementations, to track the credit card 104 via the electronic label 106, the interrogating device 102 may first establish a connection with the electronic label 106. The tracking application 108, in some implementations, may include a pairing algorithm including a user interface for setting up a connection with the electronic label 106. In pairing the electronic label 106 with the interrogating device 102, in some implementations, the user may be presented with a series of options regarding the credit card 104 associated with the electronic label 106. In some examples, the user may be provided the option to select a geographic range for pairing with the credit card 104, identify the credit card 104 with a name, or select an alert mechanism to use when the connection between the interrogating device 102 and the credit card 104 becomes broken. To pair with the electronic label 106, in some implementations, the interrogating device 102 may be brought within close proximity of the electronic label 106. For example, in the circumstance of an RFID tag, the interrogating device 102 may be brought within a range of about four centimeters or fewer for pairing purposes. In some implementations, the tracking application 108 and/or the interrogating device 102 may provide an indication regarding successful pairing (e.g., audible tone, graphic message, etc.).

Once paired, in some implementations, the tracking application 108 may maintain a communication channel with the electronic label 106 to verify presence of the credit card 104 within communication range of the interrogating device 102. In some implementations, the tracking application 108 may periodically poll or detect a transmission from the electronic label 106 to ascertain availability. The communication range, in some implementations, may be associated with a geographic range (e.g., a radius surrounding the interrogating device 102). The geographic range, in some implementations, may be selected by a user, for example during setup of the tracking application 108 or through configuration options regarding the electronic label 106 pairing with the tracking application 108. In some implementations, the geographic range may be adjusted at some point after having initially configured a pairing between the electronic label 106 and the tracking application 108. For example, the tracking application 108 may be accessed from the interrogating device 104 or via a web-based portal 118 (described in further detail below) to adjust the initial setting of the geographic range.

In some implementations, a different geographic range may be established for each electronic label paired with the interrogating device 102. For example, a geographic range of twenty feet may be established between the interrogating device 102 and the electronic label 106, while a geographic range of eighty feet may be established between the interrogating device 102 and a second electronic label (not illustrated). The geographic range, for example, may be a range the user anticipates maintaining between the interrogating device 102 and each of the paired items. For example, if the user becomes separated from the credit card 104 by more than twenty feet, the user may be concerned that the credit card 104 has been misplaced (e.g., left on the table at a restaurant) or stolen. In this example, the user may desire an alert regarding the loss of signal from the electronic label 106 so that the user may determine the location of the credit card 104.

In some implementations, the tracking application 108 may use a memory 114 for storing information 116 regarding each electronic label paired with the interrogating device 102 such that, upon loss and return of power to the interrogating device 102, the information 116 may be maintained such that, upon regaining power, the tracking application 108 may continue to track each electronic label without need for re-pairing each electronic label with the interrogating device 102. For example, information 116a regarding a transmission signature or signal between the interrogating device 102 and the electronic label 106 may be written to a hard drive area of the interrogating device 102. In another example, the information 116 a may be written to a networked storage region (not illustrated) accessible to the interrogating device 102 such that, even if the interrogating device 102 is shut down for minutes, hours, days, weeks, or even months, upon powering back up and executing the tracking application 108, each electronic label, such as the electronic label 106, (assuming still present and transmitting within the geographic area) may be automatically identified.

In some implementations, the tracking application 108 may include the web-based portal 118 for accessing information regarding tracked items. For example, the web-based portal 118 may allow a user to configure or manage the tracking of one or more electronically-labeled items, such as the credit card 104. In some implementations, the web-based portal 118 may include statistics and metadata regarding tracked items including, in some examples, a date tracking began, a number of times a connection was broken between a particular item and the interrogating device 102, a name or other identifying characteristic (e.g., last 4 digits of credit card number) for each monitored item, and a geographic range associated with each monitored item. In some implementations, upon loss or replacement (e.g., upgrade) of the interrogating device 102, information regarding tracked electronic labels may be transferred or configured to be transferred to a new interrogating device from the web-based portal 118 or other accessible network-based storage location.

In some implementations, a fund transfer device such as a credit card, debit card, stored value card, or electronic purse system may include an electronic label added, in some examples, at time of manufacture or by a lending institution. Upon receiving a fund transfer device such as the credit card 104 from a financial institution, in some implementations, the holder of the fund transfer device may apply for a tracking feature (e.g., the tracking application 108), for example via an account with the financial institution. In some implementations, application for the tracking feature may include downloading a tracking application (e.g., the tracking application 108) to a user device (e.g., the interrogating device 102). In some implementations where the tracking application 108 is provided in association with a fund transfer device, the tracking application 108 may be configured to issue an alert to the financial institution regarding detection of a broken connection. For example, should the broken connection fail to be remedied for a certain period of time, or should the fund transfer device be used during a period of broken connection, in some implementations, the financial institution may, in some implementations, place a temporary hold upon the account associated with the monitored fund transfer device to avoid improper charges.

Although the system 100 is illustrated as a system for tracking personal items using a portable device, in other implementations, similar uses and mechanisms for short range tracking of electronic labels may be applied to systems involving an interrogating device located in a substantially stationary location with respect to the electronic labels being tracked. Turning to FIG. 1B, in some implementations, a home security system 120 for monitoring valuables may include a tracking application 122 and an interrogating antenna 124 provisioned in home electronics equipment 126 such as, in some examples, a set top box, multimedia control center, home security control unit, or personal computer. The home electronics equipment 126, in some implementations, may be directly or wirelessly connected to a display 128 (e.g., a computer monitor, built-in or remote security monitor, television, etc.) to allow the user to interact with a user interface 130 of the tracking application 122. In other implementations, the user may interact with the user interface 130 through a web portal (e.g., as described in relation to FIG. 1A), for example delivered to a home computer or other electronic computing device.

In some implementations, a user may pair a set of electronic labels with the antenna 124 of home electronics equipment 126, then apply each electronic label, such as an electronic label 132, to any number of valuable items within an established signal range of the home electronics equipment 126 (e.g., approximately a room, the home, the property perimeter, etc.). For example, the electronic label 132 may be applied to a laptop computer 134.

Upon discovering loss of connection with the electronic label 132, in some implementations, the home electronics equipment 126 may issue an alert (e.g., alarm, visual alert upon the display 128, etc.) or trigger an alert via another device (e.g., trigger an alert mechanism on a user device such as a smart phone or tablet computer, dial 9-1-1 via a telecommunications connection, etc.). In some implementations, the home electronics equipment 126 may trigger an auxiliary security mechanism through issuing a signal or information to an external system (e.g., a home security system, longer range tracking system such as LoJack®, etc.).

Although the system 120 has been described in relation to home security, in some implementations, the same or a similar system may be applied in a business or retail environment to deter theft. For example, each item within an antique store may include an electronic label such that, upon removing an item from the vicinity (e.g., as established by a geographic area) prior to paying, an alert such as an audible alarm may be triggered. Further to the example, at point of checkout, the register may include a mechanism for deleting an electronic label associated with the item from the tracking system. Additional examples may involve shipping crates on a carrier vessel, livestock on a farm, or children in a preschool. Each of these various examples may involve varying hardware and software aspects depending upon the needs of the situation. For example, children may be tracked via electronic labels applied to a personal item (e.g., name badge, clothing label, etc.), while livestock may be tracked via an implanted microchip electronic label.

In some implementations, within a larger space (e.g., a store including a number of departments defined by individual geographic regions), a system-wide tracking application may support the hand-off of monitoring from one monitoring device (e.g., a monitoring station positioned within a first region or department of the store) to a second monitoring device (e.g., a monitoring station positioned within a second region or department of the store). In this manner, if the footprint of a store ranges beyond a geographic range of the electronic labels used in the tracking system, items may still be tracked within the confines of the store, for example to deter shoplifting. In some implementations, the hand-off of monitoring between the first monitoring device and the second monitoring device may include presenting an alert to a staffed security system. For example, if the item is a high theft or high price item, a security system actively monitored by security personnel may be provided with information regarding the physical movement of the item.

In some implementations, two items may both include electronic labels such that each item may track the other item. Turning to FIG. 1C, in some implementations, a tracking system 140 may include a personal item such as a key fob 142 enhanced with tracking mechanisms (e.g., a tracking algorithm 144, an antenna 148, and an electronic label 146) for paired communication with the interrogating device 102. As shown, the interrogating device may be enhanced with an electronic label 150 (e.g., built in or applied externally) to enable two-way tracking between the interrogating device 102 and the key fob 142. In some implementations, each of the tracking algorithm 144, the antenna 148, and the electronic label 146 may be either attached externally or built into internal electronics of the key fob 142. In a particular example, the tracking algorithm 144 and the antenna 148 may be built into internal electronics of the key fob 142, while the electronic label 146 may be attached to the exterior of the key fob 142. In some implementations, in a manner similar to that described in relation to FIG. 1A, the electronic label 150 of the interrogating device 102 may be paired with the antenna 148 of the key fob 142, while the electronic label 146 of the key fob 142 may be paired with the antenna 112 of the interrogating device 102. In pairing the electronic label 150 of the interrogating device 102 with the tracking algorithm 144 of the key fob 142, in some implementations, a simple user interface (e.g., push button on the key fob 142) may be used as a pairing mechanism. Further, the key fob 142 may, in some implementations, indicate success of pairing through an output mechanism such as, in some examples, an audible chirp, flashing light emitting diode (LED), or tactile vibration.

Upon pairing, if the owner of the interrogating device 102 wanders out of range of the interrogating device 102 while carrying the key fob 142, in some implementations, the tracking algorithm 144 may detect the broken connection between the antenna 148 of the key fob 142 and the electronic label 150 of the interrogating device 102 and issue an alert to the user using an alert mechanism accessible to or built into the key fob 142 such as, in some examples, a speaker, light emitting display (LED), or a vibrating tactile indicator. In some implementations, further to the example, the tracking algorithm 144 of the key fob 142 may transmit a signal (e.g., using a Bluetooth®, Wi-Fi™, or other communications mechanism) instructing the interrogating device 102 to alert the user (e.g., broadcast an audible message, sound an alarm ring tone, etc.). The signal issued by the tracking algorithm 144, for example, may be recognized by the tracking application 108 installed on the interrogating device 102, and the tracking application 108 may, in response, issue the alert.

In some implementations, two items may be configured using a localized tracking mechanism, while a third device may include a tracking application configured to receive an out of range signal issued by one or more of the first item and the second item. Turning to FIG. 1D, in some implementations, a system 150 for monitoring the proximity of a service dog 152 to a handler 154 by the interrogating device 102 may include a first tracking algorithm 156 provisioned for the handler 154 and/or a second tracking algorithm 158 provisioned for the service dog 152. At least one of the first tracking algorithm 156 and the second tracking algorithm 158, in some implementations, may be configured to communicate with the interrogating device 102 in the event of a broken connection of a signal pairing between the service dog 152 and the handler 154. In this manner, one or both of the tracking algorithms 156, 158 may alert a third party of a potential risk situation.

The first tracking algorithm 156, in some implementations, may communicate via a first antenna 160 to established a paired connection with a first electronic label 162 provisioned for the service dog 152. The first tracking algorithm 156 and the first antenna 160, in some implementations, may be built into a personal item worn by the handler such as, in some examples, a watch, medical bracelet, or pendant. In other implementations, the first tracking algorithm 156 and first antenna 158 may be built into a wheel chair or other mobility tool used by the handler 154. The first electronic label 162, in some implementations, may be built into a personal item worn by the service dog 152 such as, in some examples, a collar, harness, or service vest. In other implementations, the first electronic label 162 may be implanted in the service dog 152, for example as an embedded micro chip.

Similarly, in some implementations, the second tracking algorithm 158 may communicate via a second antenna 164 to established a paired connection with a second electronic label 166 provisioned for the handler 154. The second tracking algorithm 158 and/or the second antenna 166, in some implementations, may be built into a personal item worn by the service dog 152 such as, in some examples, a collar, harness, or service vest. In other implementations, the second tracking algorithm 158 and/or the second antenna 166 may be implanted in the service dog 152, for example as an embedded micro chip. The second electronic label 166, in some implementations, may be attached to or built into a personal item worn by the handler such as, in some examples, a watch, medical bracelet, or pendant. In other implementations, the second electronic label 166 may be built into or attached to a wheel chair or other mobility tool used by the handler 154.

The first tracking algorithm 156, in some implementations, may register, with the interrogating device 102, the pairing of a signal with the first electronic label 162. For example, the first tracking algorithm 156 may relay information to the interrogating device 102 regarding success of pairing with the first electronic label 162 including, in some implementations, information regarding the signal established (e.g., signal signature, approximate range, etc.). Similarly, the second tracking algorithm 158, in some implementations, may register, with the interrogating device 102, the pairing of a signal with the second electronic label 166.

Should the handler 154 become separated from the service dog 152 (e.g., the signal pairing between the first antenna 160 and the first electronic label 162 becomes broken), in some implementations, the first tracking algorithm 156 may issue an alert signal to the interrogating device 102 via a communication mechanism accessible to the first tracking algorithm 156 (e.g., via Bluetooth®, Wi-Fi™, cellular, or other wireless communication). The tracking algorithm 108 installed upon the interrogating device 102 may, in turn, trigger one or more alert mechanisms, in some implementations, to alert a caregiver or other individual of the separation of the service dog 152 from the handler 154. Similarly, if the second tracking algorithm 158 detects a broken connection between the second antenna 164 and the second electronic label 166, in some implementations, the second tracking algorithm 158 may issue an alert signal to the interrogating device 102.

In some implementations, both the first tracking algorithm 156 and the second tracking algorithm 158 may be configured to communicate signals, alerts, and/or other information to the interrogating device 102. For example, if a signal regarding a broken connection is received by the interrogating device 102 from each of the first tracking algorithm 156 and the second tracking algorithm 158, it may be assumed that the handler 154 has become separated from the service dog 152. Further to the example, if only one of the tracking algorithms 156, 158 issues an alert, it may be reasonable to conclude that a malfunction has occurred, such as electronics supporting the other tracking algorithm 156, 158 has lost power or become damaged. In this circumstance, the caregiver at the interrogating device 102 may consider the alert to be less critical.

In other implementations, for example for simplicity or for lower cost, only one of the tracking algorithms 156, 158 may be provisioned. For example, the handler may have the first tracking algorithm 156 and the first antenna 160, but not the second electronic label 166. Similarly, the service dog 152 may have the first electronic label 162, but not the first tracking algorithm and the first antenna 164.

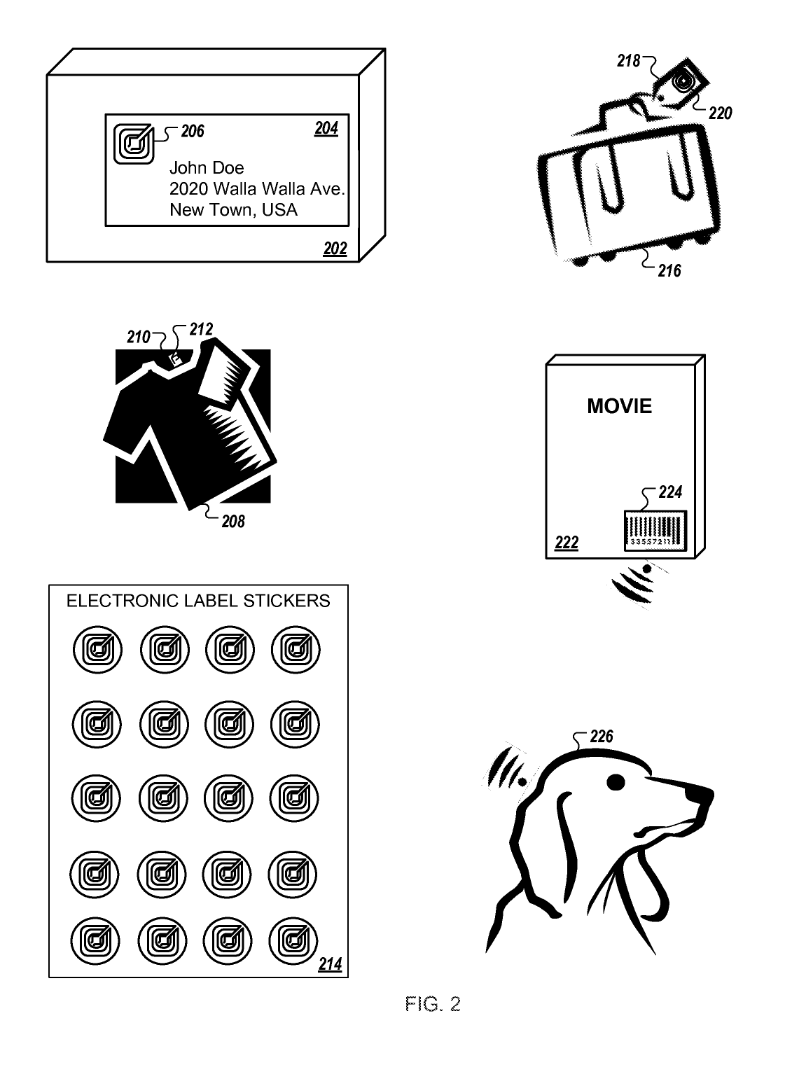

FIG. 2 illustrates versions of electronic labels which may, in some implementations, be used to track items. In various implementations, for example involving shipping products (e.g., a container vessel, air carrier, train car, warehouse, or postal service system), a shipping label 204 including an electronic label 206 may be applied to a package or container 202. The electronic label 206, in some implementations, may be sized appropriately to provide a signal strength for use in a large environment, such as a container ship or warehouse environment.

In various implementations, for example involving tracking individuals in an individual or group setting (e.g., parent tracking a child, teacher tracking students, care center tracking patients, etc.) or involving tracking textile products (e.g., apparel, towels, bedding, rugs, etc.) in a retail, shipping, or warehouse setting, an electronic label 212 may be applied to a garment tag 210 attached to a textile item such as a shirt 208. In other implementations, an electronic label may be directly stitched into the fabric of the textile product.

In various implementations, for example in the circumstance of an individual interested in tracking a number of personal belongings, the individual may purchase a set of electronic label stickers 214 designed to function with an associated tracking application. The tracking application, in some implementations, may be available for purchase or for free download. In some examples, the tracking application may be available through a web site, an application store associated with a personal electronics device, or in a “hard copy” form written to a non-transitory computer-readable medium such as a compact disk (CD), digital video disk (DVD), or Flash drive. A non-transitory computer-readable medium containing a copy of the tracking application, in some implementations, may be sold as a package with the electronic label stickers 214. In some implementations, the electronic label stickers 214 may include a decorative design or pattern on the surface such as, in some examples, a team logo, organization logo, trademark character, or other image.

In various implementations, for example in the circumstance of luggage tracking within an airport, train station, or other transit environment, a baggage tag 218 including an electronic label 220 may be attached to a piece of luggage 216.

In various implementations, for example in the circumstance of a retail, shipping, or warehouse setting, an electronic label may be embedded in a machine-readable packaging label 224 (e.g., a bar code label, matrix bar code label, Quick Response (QR) code label, etc.) of a retail item such as a DVD box 222. In some implementations, the machine-readable packaging label 224 may be attached to the packaging of the DVD box 222, or built into the structure of the packaging of the DVD box 222. In the circumstance of a retail item lacking external packaging, in some implementations, the electronic label may be embedded in a machine-readable packaging label portion of the retail item (not illustrated).

In various implementations, for example in the circumstance of pets, livestock, or other living creatures kept within a contained environment (e.g., zoo, aviary, research laboratory, etc.), an electronic label may be implanted beneath the skin of the animal such as a dog 226. In some implementations, the electronic label may be designed into a micro chip implant, such as an implantable micro chip containing information related to the animal.

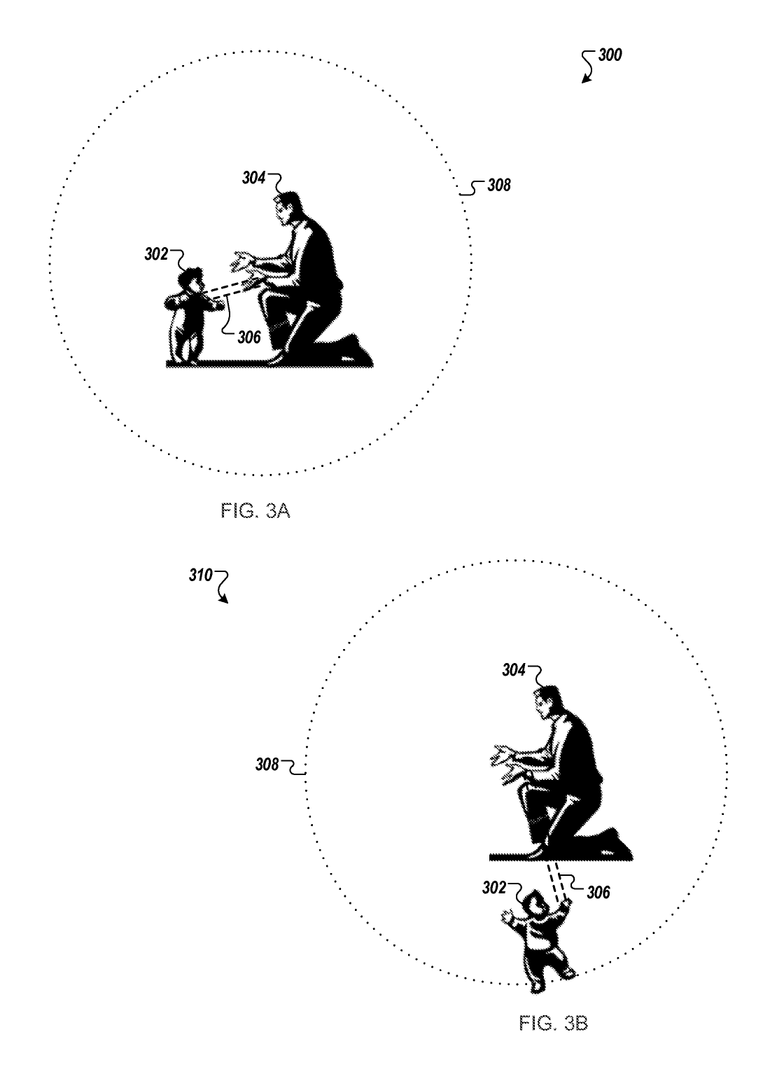

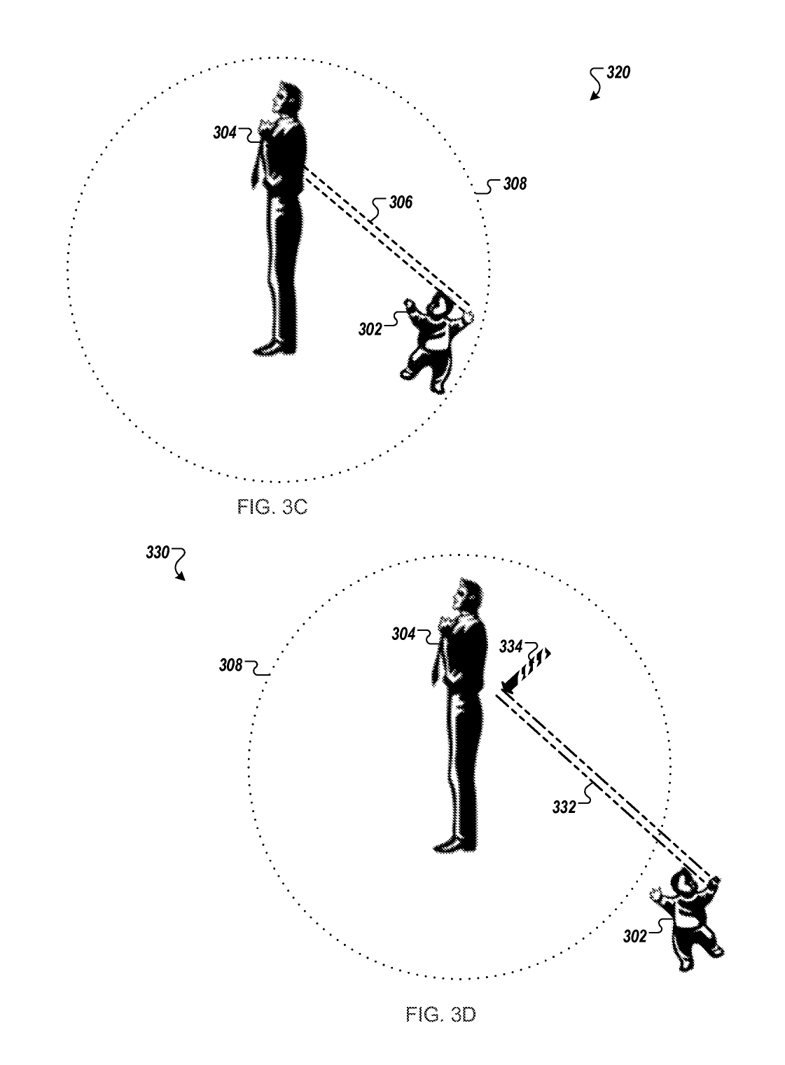

FIGS. 3A through 3D illustrate a scenario for monitoring a connection between an electronic label attached to a toddler 302 and an interrogating device attached to a parent 304. In some implementations, the parent 304 may be wearing a wrist-based interrogating device (e.g., a watch including a tracking algorithm and antenna, etc.) while the toddler 302 may be wearing a wrist-based electronic label (e.g., bracelet, etc.). Beginning with FIG. 3A, a first scene 300 illustrates the existence of a signal 306 between the parent 304 and the toddler 302. The signal 306 may be configured, for example, for communication within an approximate range 308, illustrated as a dotted line.

Turning to FIG. 3B, in a second scene 310, the toddler 302 may be moving away from the parent 304, while the signal 306 may continue as a connection (e.g., as monitored by a tracking algorithm in the parent interrogating device). The toddler 302, as illustrated, appears to be moving towards the edge of the range 308.

As shown in FIG. 3C, in a third scene 320, the parent 304 has his back turned to the toddler 302, while the toddler 302 appears to continue to move towards the edge of the range 308. As illustrated, the connection 306 may still be detectable by the interrogating device of the parent 304.

Turning to FIG. 3D, in a fourth scene 330, the toddler 302 appears to have exited the range 308 of communication between the interrogating device of the parent 304 and the electronic label of the toddler 302. A broken connection, illustrated by an arrow 334, may exist at a gap between a signal 332 supplied by the electronic label of the toddler 302 and the interrogating device of the parent 304. In some implementations, upon detection of the broken connection between the interrogating device of the parent 304 and the electronic label of the toddler 302, the parent 304 may receive an alert, for example issued by the interrogating device or from another device within communication range of the interrogating device.

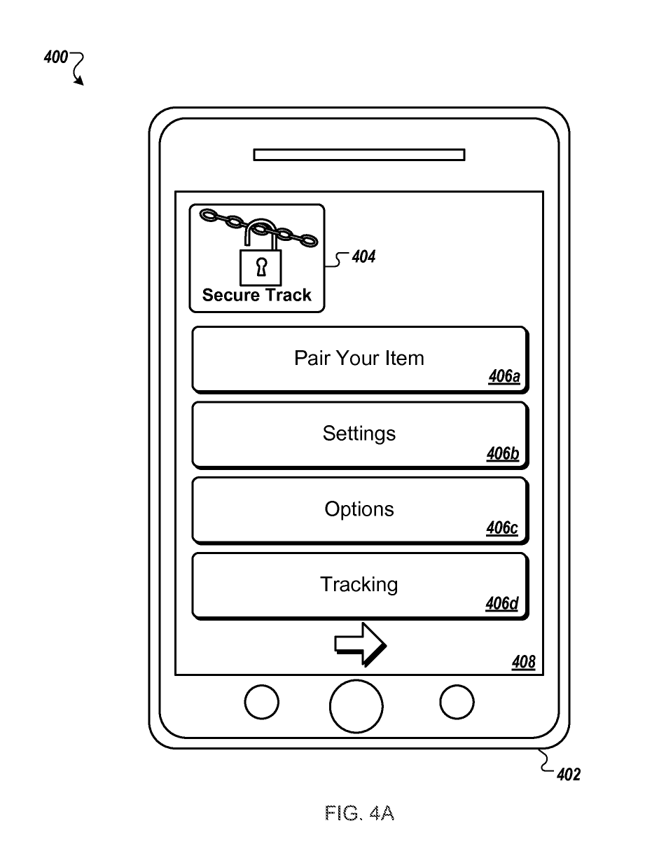

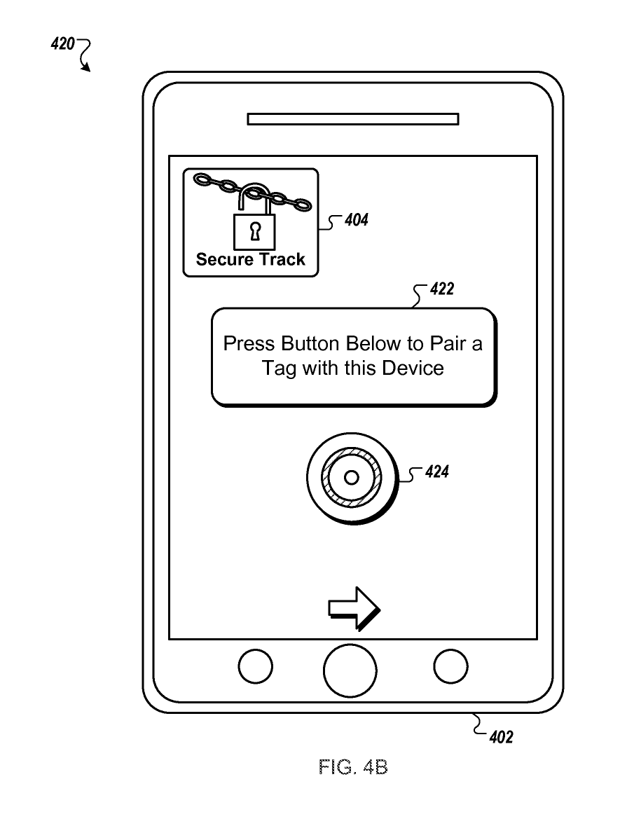

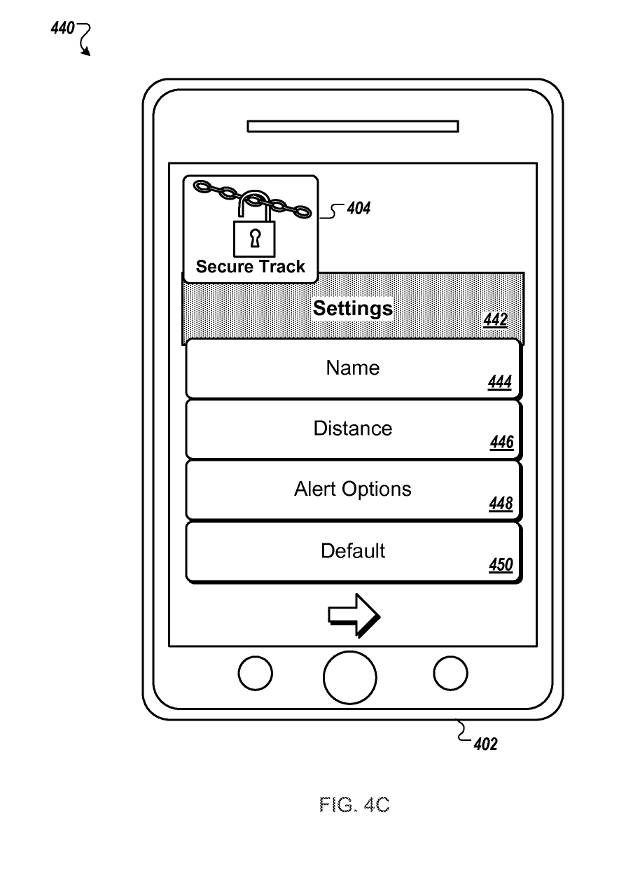

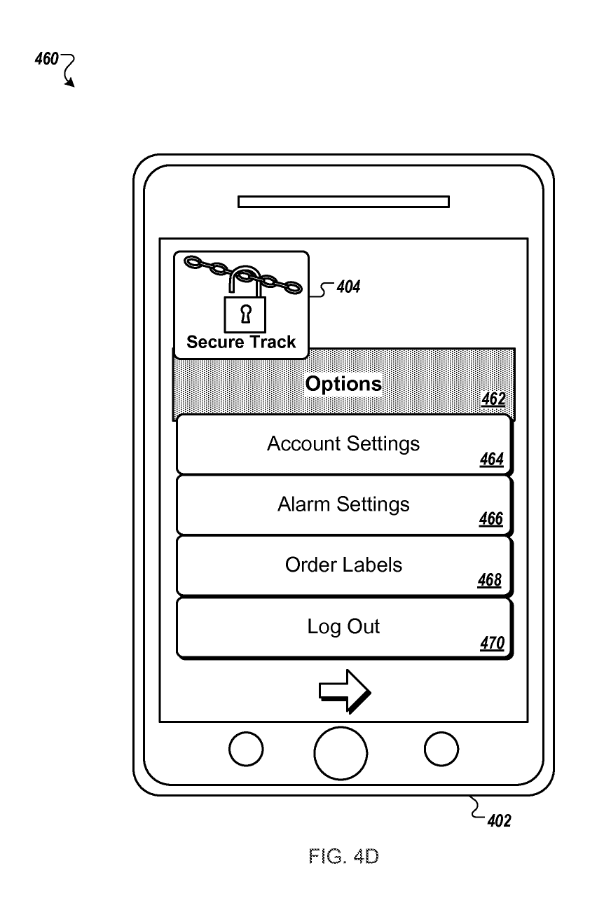

Many other implementations are possible. FIGS. 4A through 4D illustrate various implementations of user interfaces for configuring and using a tracking application for localized tracking items with electronic labels. As shown in FIG. 4A, in some implementations, a first screen shot 400 of a tracking application executing on a portable computing device 402 may include an application logo 404 and a series of main menu buttons 406. A user may install the tracking application, in some implementations, to track the presence of any number of electronic labels within short range communications of the portable computing device 402.

A first menu button 406a labeled “Pair Your Item”, in some implementations, may provide a user, upon selection, with the ability to pair an electronic label with the portable computing device 402. In some implementations, to pair an electronic label with the portable computing device 402, the electronic label may be brought in close proximity with the portable computing device 402. In this manner, for example, the portable computing device can acknowledge the transmission from a near electronic label as opposed to other electronic labels within the vicinity. In some examples, an electronic label may be brought within twelve inches, two inches, or one inch of a screen area 408 of the portable computing device 402. In some implementations, a nearness of the electronic label may depend upon the type of electronic label. For example, an initial range of a passive type RFID tag, for activation purposes, may be within two to four centimeters.

Upon selection of the first menu button 406a, in some implementations, a user interface of the tracking application may invite the user to indicate a type of electronic label prior to attempting to pair with the electronic label. In some examples, the type of electronic label may include an electronic label configured to communication via one or more of a radio frequency signal, Bluetooth®, Near field communication (NFC), or Wi-Fi™ using at least one of a passive (e.g., non-powered), semi-passive (battery back-up powered), or active (e.g., direct powered) transmitter. In some implementations, information printed upon an electronic label may be indicative of a type of label. For example, one or more of text, barcode, two dimensional code, or logo graphic may indicate a type of electronic label. In some implementations, a user may be prompted via the user interface of the tracking application to provide the printed information on the electronic label for reading purposes. In some examples, the portable computing device 402 may be used to read printed information on the electronic label using a camera, bar code scanner, or other imaging component built into the portable computing device 402.

In some implementations, electronic labels included with two devices may be paired with each other during a pairing process. For example, an electronic label reader of a first device may recognize the electronic label of the portable computing device 402, while the electronic label reader of the portable computing device 402 may recognize the electronic label of the first device. In some implementations, cross-pairing two electronic devices may involve a “handshake” mechanism, for example where the two devices are physically touched together or held in very close proximity to each other.

In some implementations, upon successful pairing, the portable computing device 402 may provide a user with an indication of success. Such alert mechanism may include, in some examples, audio, graphic, and/or tactile feedback.

Turning to FIG. 4B, a second screen shot 420 of a tracking application executing on the portable computing device 402 may, in some implementations, be presented to a user upon selection of the “Pair Your Item” menu button 406a (as shown in FIG. 4A). The second screen shot 420, in some implementations, may include a message 422 directing the user to “Press Button Below to Pair a Tag with this Device.” Beneath the message 422, in some implementations, a button-style touch screen control 424 may be presented. In some implementations, upon selection of the touch screen control 424, the portable computing device 402 may provide an indication to the user that pairing is underway. In some examples, the indication may include audio (e.g., “white noise”, “elevator music”, an audible hum, an egg timer tick, or other consistent audible feedback indicating a process is taking place, etc.), graphic (e.g., brightness variation, change of screen appearance, change of button appearance, textual message indicating a process is taking place, etc.), or tactile (e.g., pulsed or constant vibration, etc.) feedback to the user from the portable computing device 402.

In some implementations, the portable computing device 402 may fail to pair with a particular electronic label. In some examples, the electronic label may already be paired to the portable computing device 402, the electronic label may be incompatible with a tracking application executing on the portable computing device 402, or the electronic label may not be within reading range of the portable computing device 402. In this circumstance, in some implementations, an error indication may be provided to the user, such as an error message or a help screen.

If, instead, pairing between the portable computing device 402 and the electronic label is successful, in some implementations, the portable computing device 402 may provide an audio (e.g., verbal message, fanfare, one or more chirps, beeps, or other tones, etc.), graphic (e.g., brightness variation, change of screen appearance, change of button appearance, textual message indicating success, etc.), and/or tactile (e.g., pulsed or constant vibration, etc.) indication of success.

In some implementations, upon success in pairing, the portable computing device 402 may present a new screen shot, such as a screen shot 440 illustrated in FIG. 4C, inviting the user to provide details regarding the pairing. These details, in some examples, may include a name for the item including the electronic label, a distance indicating a geographic range for tracking the electronic label, and/or alert mechanisms for use upon detection of a broken connection. Alternatively, as shown in FIG. 4A, a second menu button 406b labeled “Settings”, in some implementations, may provide a user with the ability to customize, in some examples, tracking settings, alert mechanism settings, or label identification settings. For example, the second menu button 406b of FIG. 4A, upon selection, may generate the screen shot 440 as shown in FIG. 4C.

Turning to FIG. 4C, a settings menu 442 includes a “Name” control 444, a “Distance” control 446, an “Alert Options” control 448, and a “Default” control 450. Selection of the “Name” control 444, in some implementations, may provide the user with an interface for entering descriptive information regarding the item including the electronic label. For example, a user may enter “Local Bank Debit Card” to describe a first paired item. In the case of a paired item including encoded item information (e.g., a bar coded retail item, etc.), rather than entering textual information regarding each item, in some implementations a bar code or other identification marking may be scanned (e.g., by the personal computing device 402 or another device in communication with the personal computing device 402) to import information regarding the item. Other options, in some implementations, may include associating an image (e.g., a photo of the tracked item) with the electronic label or entering recovery data (e.g., a phone number to customer service to report a stolen credit card) regarding the tracked item.

Selection of the “Distance” control 446, in some implementations, may result in presentation the user of a user interface providing an option of associating a geographic region with the paired electronic label. In some implementations, the user may be provided the opportunity to enter a specific distance (e.g., in feet). A number of predetermined options, in some implementations, may be presented to the user for selection, for example in a drop-down menu or radio button presentation. In a particular example, a user may be provided the opportunity to select a range of five feet, ten feet, twenty feet, or thirty feet. An available distance range (e.g., two inches to sixty feet, etc.), in some implementations, may be presented to the user. The available range, in some examples, may depend upon a type of electronic label or type of communication used between the portable computing device 402 and the electronic label. In some implementations, the user may be provided with the option of labeling one or more selected range options. In a particular example, the user may label a range of fifteen feet as “room,” a range of five feet as “my wallet,” and a range of sixty feet as “at home.” Subsequently, in some implementations, a user may configure additional paired electronic labels using a previously labeled range. In some implementations, rather than defining a geographic distance, a user may enter GPS dimensions of a facility or another perimeter-reporting mechanism may be provided to the user to allow the user to correspond the footprint of a physical location to a tracking region.

Returning to the settings menu 442, the “Alert Options” control 448, upon selection, may in some implementations result in presentation to the user of one or more alert mechanisms for configuration. In some examples, an alert may include an audio alert (e.g., alarm, ring tone, verbal message, etc.), a graphic alert (e.g., strobing screen, textual message, graphic indicator, etc.) or a tactile alert (e.g., pulsed or constant vibration). The alert mechanism(s), in some implementations, are configured for triggering by the portable computing device 402 upon detection of a broken communication connection with the paired electronic label. In some implementations, an alert mechanism may include a signal provided to a third device, such as a text message or telephone call issued to a provided number, an email issued to a provided address, or a signal issued through a short or long range communication system (e.g., Bluetooth®, Wi-Fi™, cellular, or other Internet communication) to a separate device to activate an alarm mechanism within the separate device. In some examples, a signal issued to a separate device may include a signal issued to a security system in a retail store environment to trigger an audible alarm or a signal issued to a vehicle communications system to trigger a driver communications system warning mechanism. In some implementations, an alert mechanism may include invoking a longer range tracking mechanism (e.g., GPS, etc.) to track the item once the item has left the range of communication established with the tracking application.

In some implementations, an electronic label paired with the system may become damaged or otherwise no longer operate. For example, an adhesive label may peel off of a credit card or become damaged. In this circumstance, a replacement electronic label may be associated with a pre-existing pairing configuration, for example through selection of pre-existing item information via selection of the “Name” control 444. In some implementations, distance settings and/or alert settings associated with pre-existing pairing configuration may also be applied to the new electronic label pairing.

The “Default” control 450 within the settings menu 442, in some implementations, may provide the user with a mechanism, upon selection, to restore default settings to the pairing between the portable computing device 402 and the paired electronic label. The default settings, in some examples, may include a default distance, default alert options, and/or default item identification information.

Returning to FIG. 4A, a third menu button 406c labeled “Options”, in some implementations, may provide the user, upon selection, with the ability to establish account settings within the tracking application, generate default tracking settings for tracking one or more electronic labels, or create a purchase order for additional electronic labels to be used with the tracking application. Turning to FIG. 4D, a screen shot 460, in some implementations, may include an options menu 462 presenting to the user, in some examples, an “Account Settings” control 464, an “Alarm Settings” control 466, an “Order Labels” control 468, and a “Log Out” control 470. In some implementations, selection of the “Account Settings” control 464 may result in presentation to the user of one or more input controls for specifying account information associated with the tracking application. Account information may include, in some examples, an account name, password, associated email address, user contact information (e.g., home address, telephone number, etc.), or a software update delivery mechanism (e.g., automatic, prompted, email notification, etc.). In some implementations, an account setting may include a web portal address or network storage area for storing and/or managing information regarding the tracking of one or more electronic labels.

Turning to the “Alarm Settings” control 466, upon selection, in some implementations one or more input controls may be presented to the user to specify mechanisms for alerting the user once a connection has been broken between the portable computing device 402 and a paired electronic label. In some implementations, a user may be provided with a ring tone selection or file browsing mechanism to import an audio file for use as an alarm.

An alarm setting, in some implementations, may include configuration with a separate device such that an alarm signal issued by the portable computing device 402 may trigger an alarm via the separate device. In some implementations, configuration with a separate device may include pairing with the separate device, for example through a Bluetooth® or Wi-Fi™ communication. The alarm settings, in some implementations, may include indication of a telephone number or email address to contact in the event that a connection between the portable computing device 402 and a paired electronic label is broken. In some implementations, an alarm setting option may include an indication of a back-up tracking mechanism to use in the event that the connection is broken between the portable computing device 402 and the paired electronic label. Back-up tracking mechanisms, in one example, may include GPS tracking.

In some implementations, the user may be provided the opportunity, for example through the “Alarm Settings” control 466, to apply a hierarchy of alarm mechanisms. For example, upon initial communication failure with a paired electronic label, the tracking software may be configured to issue a localized alert via the portable computing device 402. Upon failure to reestablish communication with the electronic label, for example after a set period of time (e.g., five seconds, ten seconds, etc.) or a set number of attempts, in some implementations a second level of alert hierarchy may include graphically indicating to a user a direction in which the electronic label was last detected. At a third hierarchical level, in some implementations, a user may be prompted to provide a confirmation that the item has been misplaced or stolen. Upon receipt of confirmation, for example, an alternate tracking mechanism or a security alert mechanism may be enacted (e.g., track item via GPS, alert authorities of theft, etc.). In some implementations, the user may be prompted to provide a password with confirmation prior to an alternate tracking mechanism or security mechanism being invoked.

Returning to the options menu 462, upon selection of the “Order Labels” control 468, in some implementations, the user may be presented with a dialog for placing an order for additional electronic labels to attach to items for tracking purposes. The electronic labels, in some implementations, may include an adhesive backing for application to an item. In some implementations, a variety of types of labels may be available to the user, for example based upon a desired range, a desired application, or a desired style. For example, labels may be customized to user interests or preferences, such as sports logo labels, licensed character labels, or monogram labels. In some implementations, the tracking application installed upon the portable computing device 402 may be free of charge to the user for download, while the electronic labels configured to authenticate with the tracking application may be available for purchase.

As shown in the options menu 462, in some implementations the user may select the “Log Out” control 470 to log out of the tracking application. In some implementations, logging out of the tracking application may result in password protection of the tracking application from configuration by another user, while the tracking application may continue to operate in the background of the portable computing device 402. In some implementations, as long as the portable computing device 402 is powered on, the tracking application may continue to monitor paired electronic labels. Furthermore, upon powering up after shut down, in some implementations, the tracking application may automatically re-start and attempt to locate each of the previously paired electronic labels. Selection of the “Log Out” control 470, in some implementations, may result in disabling the tracking application.

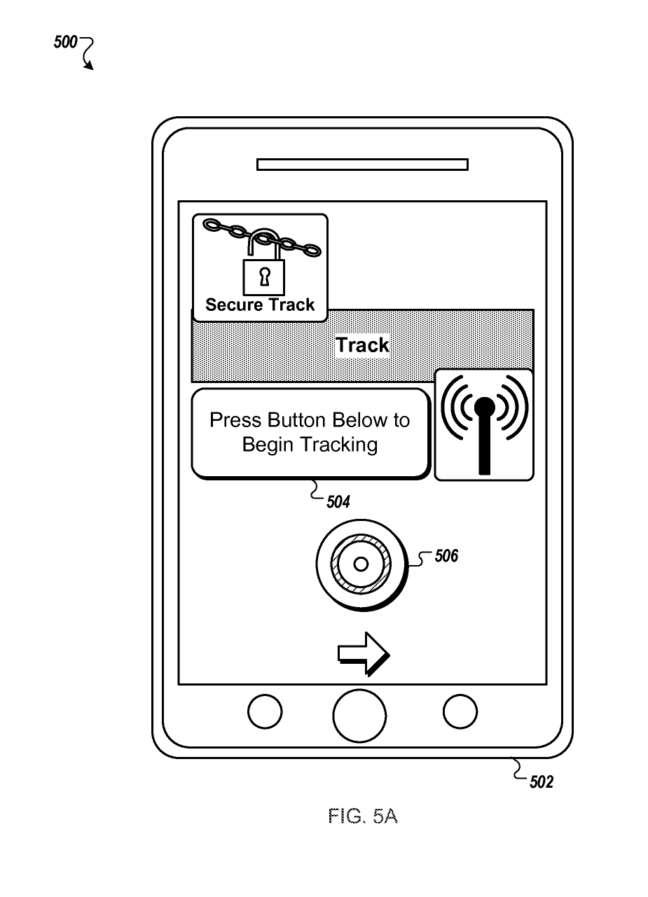

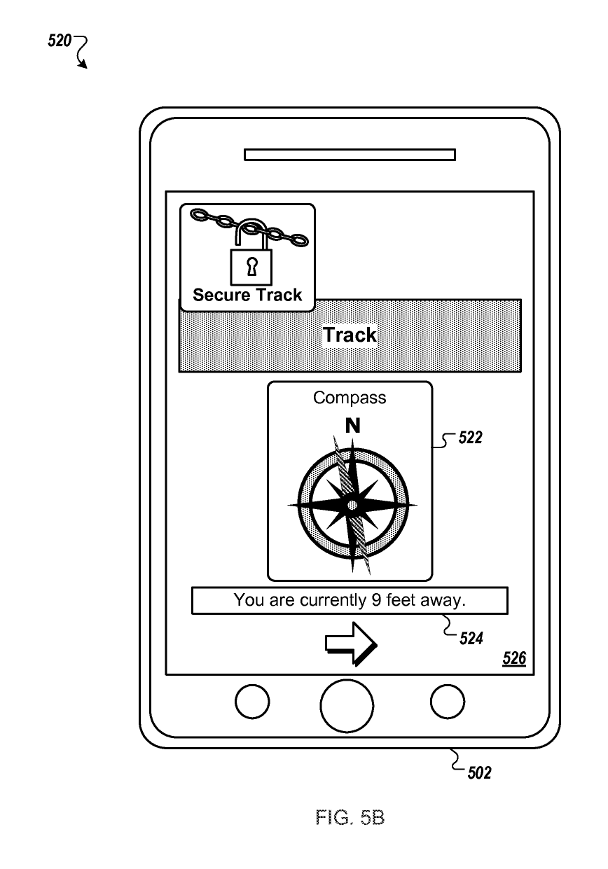

FIG. 5A and FIG. 5B illustrate a series of screen shots 500, 520 of a user interface on a wireless personal electronic device 502 for tracking items with electronic labels. In some implementations, a first screen shot 500 may be accessed after pairing at least one electronic label with a tracking application executing upon the personal electronic device 502 to begin tracking the item(s). For example, as illustrated in FIG. 4A, the fourth menu button 406d labeled “Tracking,” in some implementations, may be selectable to present the first screen shot 500.

Turning to FIG. 5A, the first screen shot 500, in some implementations, may include a message 504 labeled “Press Button Below to Begin Tracking” presented above a selectable control 506. Selection of the selectable control 506, in some implementations, may initiate tracking of one or more paired electronic labels. Upon selection of the selectable control 506, for example, a user may receive audio, graphic, and/or tactile confirmation regarding success of recognizing the availability of a transmission signal of at least one paired electronic label. In some implementations, the tracking application may present information regarding the number of electronic labels currently being tracked. During execution, the tracking application may present an icon on the screen of the wireless personal electronic device 502, for example in a corner of the display, to provide the user with immediate visual confirmation that the tracking application is actively tracking one or more electronic labels.

During tracking of an electronic label, in some implementations, the tracking application may include a seek and find functionality to help the user in locating a misplaced item with an electronic label. For example, a user may pair the wireless personal electronic device 502 with a key fob that has an electronic label. If the user should misplace the keys, the user may access, in some implementations, a tracking interface to aid in locating the current position of the keys. For example, upon misplacing the keys, the user may locate the keys (e.g., in the bedroom, kitchen, car, etc.) by walking around the house with a portable interrogating device until the portable interrogating device has again established connection with the keys. Further to this example, a user may establish a room-sized or smaller range (e.g., ten, fifteen, or twenty feet) such that, upon misplacing the keys, the user need only wander about the house with the interrogating device until communication between the interrogating device and the electronic label included with the keys has been established. In some implementations, the interrogating device may further provide a direction and/or estimated distance between the user and the misplaced item. For example, a compass functionality may be presented to the user in a display area of the portable interrogating device to aid the user in locating the misplaced item.

Turning to FIG. 5B, a screen shot 520, as illustrated, in some implementation may include a compass feature of the tracking application. The compass feature, in some implementations, may be invoked by a user for finding a misplaced item with a paired electronic label. As illustrated in a display region 526 of the wireless personal electronic device 502, for example, a graphical compass 522 may illustrate an estimation of a direction from the wireless personal electronic device 502 to the misplaced item. In some implementations, the compass feature may estimate a current distance between the wireless personal electronic device 502 and the misplaced item. For example, a message 524, as illustrated, in some implementations may present the user with an estimated distance such as, “You are currently 9 feet away.” As the user walks around carrying the wireless personal electronics device 502, in some implementations, the screen shot 520 may update with a new distance, for example as presented via the message 524, and/or a new direction from the wireless personal electronic device 502 to the paired electronic label, for example as presented by the graphical compass 522.

In some implementations, the compass feature may be provided for locating an item with a paired electronic label once a connection has been broken with the paired electronic label. In a particular example, a user may adhere an RFID tag to a tablet computer and pair the RFID tag with the wireless personal electronic device 502 using the tracking application. Once the tablet computer and the wireless personal electronic device 502, in this example, are separated by greater than a threshold distance, in some implementations a back-up tracking mechanism may be invoked. For example, a GPS feature built into the tablet computer may be utilized by the tracking application, and the tracking application may allow the user to locate the tablet computer using the tracking application (e.g., via the graphical compass 522 and/or distance estimation as presented by the message 524).

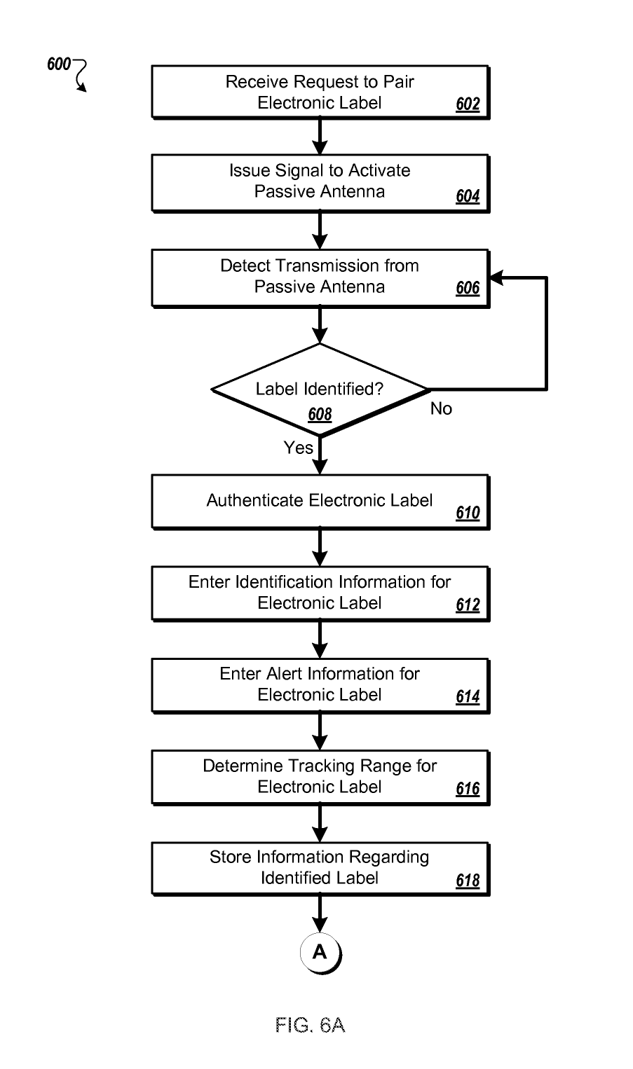

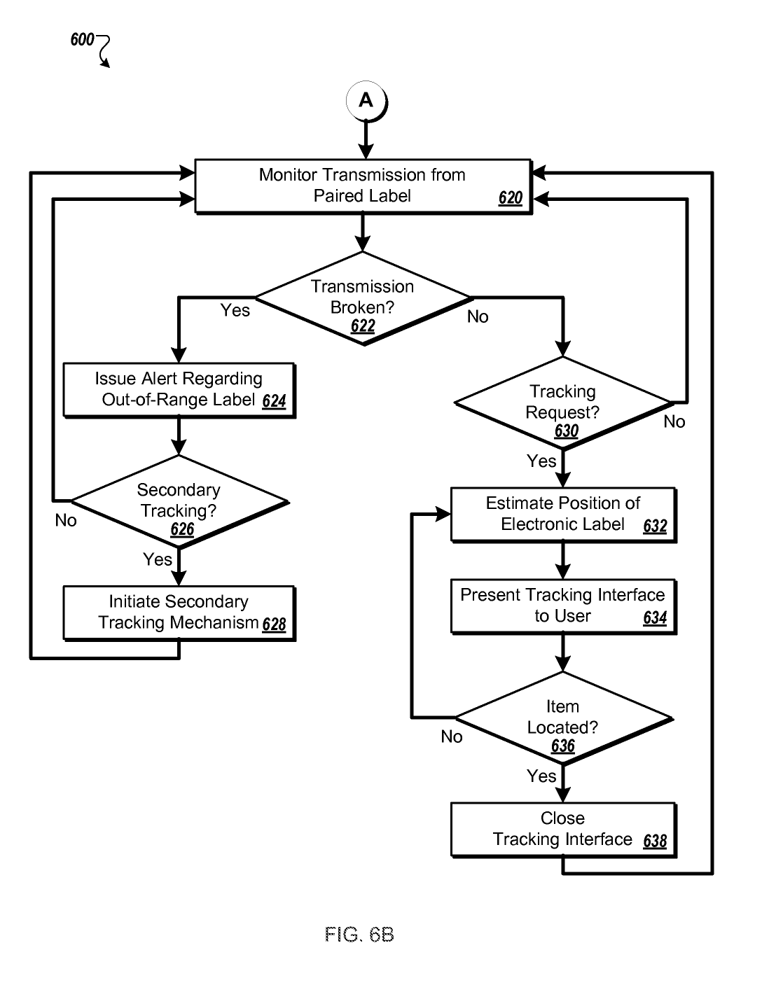

FIGS. 6A and 6B illustrate a flow chart describing a method 600 for localized tracking of items via electronic labels. The method 600 may begin, in some implementations, with receiving a request to pair an electronic label (602). In some implementations, a user may bring an electronic label or an item containing an electronic label within a threshold distance of a monitoring device and submit a request to the monitoring device to pair with the electronic label. In some implementations, the user may request pairing of the electronic label with the monitoring device through a graphical user interface of a tracking application executing upon the monitoring device. In some examples, the electronic label may include a passive mode communication devices (e.g., lacking a local power source), a semi-passive mode communication device (e.g., including battery back-up) or an active mode communication device (e.g., including its own power source). A monitoring device may use any type of short range communication technique for communicating with the electronic label such as, in some examples, radio frequency identification (RFID) or other near field communications (NFC) protocols, Wi-Fi™, or Bluetooth®.

If the electronic label includes a passive mode communication device, in some implementations, a signal may be issued to activate a passive or semi-passive antenna (604). For example, energy may be supplied by the monitoring device to activate a passive antenna of the electronic label.

The transmission signal of the electronic label may be located (606). For example, the monitoring device may scan for a transmission signal corresponding to an electronic label. In some implementations, the monitoring device may attempt to locate a transmission signal using two or more different communication protocols. If an electronic label is not identified (608), for example, using a first communication protocol, a second communication protocol, in some implementations, may be attempted. In some implementations, after a maximum number of retries or a maximum amount of time, the user may be presented with an error condition and/or a help menu for aid in troubleshooting the activation process.

Once an electronic label has been identified (608), in some implementations, the electronic label may be authenticated (610). In some implementations, an electronic label may be authenticated as an electronic label manufactured for use with the tracking application. In some examples, particular encryption information or a style of unique identifier may be used to authenticate an electronic label with the tracking application. At this point, in some implementations, the electronic label may be considered to be paired with the monitoring device.

In some implementations, identification information associated with the electronic label may be entered (612). In some implementations, identifying information may be communicated to the monitoring device within the transmission signal of the electronic label. For example, a name, unique identifier, product stock-keeping unit (SKU), or other information regarding the electronic label and/or the item having the electronic label may be provided via the transmission stream of the electronic label. A user, in some implementations, may manually enter identifying information regarding an electronic label including, in some examples, a name, unique identifier, or other information regarding the electronic label and/or the item having the electronic label. In some implementations, information regarding the item may be identified by scanning a graphic, bar code, multi-dimensional code, or other marking upon the item having the electronic label. For example, a scanning device in communication with or built into the monitoring device, such as a camera, bar code scanner, imaging sensor, or other reader may be used to import information regarding the item into the tracking application.

In some implementations, alert information associated with the electronic label may be entered (614). A user may be presented with a user interface mechanism, in some implementations, to select options associated with alerting the user of a broken connection between the monitoring device and the electronic label. For example, a user may select a particular ring tone or other audible message and/or a silent alert (e.g., tactile response such as a vibration, graphic response such as a message on a display or strobing lights, etc.). In some implementations, the user may specify a phone number or email address to contact in the event of a broken connection. Rather than entering alert information, in some implementations, the electronic label may be associated with stored alert information (e.g., entered by the user in reference to a previously paired electronic label or during setup of the tracking application, etc.).

In some implementations, a tracking range for the identified electronic label may be determined (616). In some implementations, an available tracking range may be calculated based in part upon one or more of a type of electronic label, size of electronic label, and transmission strength of a monitoring device (e.g., amount of energy via the voltage transmitted to the tag from the reader as manipulated and calculated by the tracking application). The available tracking range, in some implementations, may be based in part upon a forward link budget between the monitoring device and the identified electronic label. In some implementations, the available tracking range may be based in part upon a reverse link budget between the identified electronic label and the monitoring device.

The tracking range, in some implementations, may be defined in part through querying a user regarding a desired geographic area. In one example, a user may specify a radius, in feet, from the monitoring device. In another example, the user may specify a geographic region, such as a perimeter of a room, building, or other defined geographic space. Further to this example, a geographic range (e.g., in feet or meters) may be derived from the positioning of the tracking device and the dimensions of the geographic space. In some implementations, the determination may be made in part using environment and other factors, for example as determined through one or more sensors of the monitoring device or through a recognition of the intended use of the electronic label. In some examples, a home security deployment may take wall and other obstacle interference into consideration, while a credit card deployment may take a wallet in the back pocket interference scenario into consideration.

In some implementations, the tracking range may be calculated based in part upon impedance designed into a backscatter radiation style passive RFID tag. Based in part upon the voltage provided by the interrogating device, for example, a corresponding voltage may be induced on the antenna of the passive RFID tag. The induced voltage may lead to an induced current across the load (e.g., impedance) of the antenna of the passive RFID tag. A modulated backscattered wave correlating to the interrogating signal may be returned to the monitoring device. The voltage may be increased or decreased at the monitoring device (e.g., by a tracking application) to vary a communication range between the interrogating device and the passive RFID tag.

In some implementations, information may be stored regarding the identified electronic label (618). In some implementations, one or more of the identification information, the alert information, and the tracking range may be stored in a memory location accessible to the monitoring device. The memory location, in some implementations, may include a network-accessible storage area. In this manner, for example, the monitoring device may be damaged, replaced, and/or power cycled without losing the stored information. In some implementations a portion of the information may be shared with a separate device. For example, through a web portal or through a network-accessible storage location, a separate device such as a user personal computer or a retail store central security system may access the stored information. In some implementations, the stored information may be modified or removed via a separate device. Modifications made via a separate device, in some implementations, may be provided to the monitoring device in near real time.

Turning to FIG. 6B, in some implementations, the method 600 may continue with monitoring a transmission from the paired electronic label (620). To assure that a paired electronic label continues to be within range of the monitoring device, in some implementations, the monitoring device may periodically verify availability of communication link between the monitoring device and each paired electronic label. In some implementations, frequency of verification may depend in part upon individual user settings or a particular style of deployment for the tracking application. For example, when tracking the whereabouts of a toddler, the system may verify the transmission link more frequently than when tracking valuables within a home security deployment.

While tracking an electronic label via a monitoring device, in some implementations, a threshold for considering a connection broken may depend in part upon user settings and/or style of deployment. For example, in a mobile deployment (e.g., cell phone monitoring wallet, etc.) with unknown line-of-sight or other impediments depending upon a user's current location, the tracking application may retry a number of times or for a certain period of time prior to issuing an alert regarding broken communication. In other implementations, such as monitoring equipment within a business (e.g., where office equipment such as printers and monitors rarely move a great distance), an alert may be issued immediately upon recognizing a broken connection.

If the transmission with the electronic label is broken (622), in some implementations, an alert may be issued regarding the out-of-range electronic label (624). One or more alert mechanisms, in some implementations, may be provided in accordance with the alert information supplied in step 614. Audio, graphic, and/or tactile alert mechanisms, in some implementations, may be supplied by the monitoring device. In some implementations, a signal or message (e.g., text message, email, brief telephone message, etc.) may be provided to a third device. If, for example, a signal regarding the broken connection is supplied to a separate device, the separate device may issue one or more alert mechanisms in response (e.g., audio, graphic, and/or tactile).

In some implementations, two or more electronic labels may be logically grouped such that, upon detection of a broken signal with all of the electronic labels within the group, a single alert may be issued. For example, a user may apply electronic labels to two or more items commonly carried within a wallet (e.g., a credit card, a debit card, and a driver's license). If it is determined that connections are broken with all three of these electronic labels, in this example, an alert may be issued to the user specifying an out-of-range “wallet” rather than three separate out-of-range items. In some implementations, logical grouping of two or more electronic labels may be accomplished during configuration of each electronic label with the tracking application or through a separate user interface (e.g., through the monitoring device or through a management interface provided at a separate device, such as through a web portal). Management of electronic labels into logical groupings, in a particular example, may be handled through a web portal, where settings established via the web portal may be downloaded to the monitoring device.

If a secondary tracking mechanism has been configured (626), in some implementations, a secondary tracking mechanism may be initiated (628) to aid in locating the out-of-range electronic label. For example, once an item including an electronic label exceeds transmission range (e.g., as determined in step 622), an alternative communication mechanism may be used to locate the item such as, in some examples, GPS or Bluetooth™ signaling. The secondary tracking mechanism, in some implementations, may be used as a security measure to reclaim a stolen item. In a particular example, once a piece of office equipment has been removed from a business, a GPS-based tracking mechanism may be initiated to locate the (presumed) stolen item.

Whether or not a secondary tracking mechanism has been initiated (628), in some implementations, after issuing an alert regarding an out-of-range label (624), the transmission from the paired electronic label may continue to be monitored (620). For example, a monitoring device may continue to periodically check to determine whether the electronic label has returned within range of the monitoring device. In some implementations, if the monitoring device determines that an electronic label has returned within range, a user may be alerted regarding the reestablishment of connection between the monitoring device and the paired electronic label. For example, the transmission signal from the electronic label may have been temporarily obstructed, or the item having the electronic label may have temporarily moved outside the range of the monitoring device. In some implementations, the method of alerting the user of the renewed availability of the electronic label may be specified by the user during setup of the tracking application and/or the particular electronic label (e.g., during step 614 of entering alert information).

If, rather than being broken, a communication link with the paired electronic label is verified (622), but a tracking request is identified (630), in some implementations a current position of the electronic label may be estimated (632). A tracking request, in some implementations, may be invoked by a user to locate a misplaced item that has a paired electronic label. For example, if a user has misplaced her purse within her house, the monitoring device (e.g., a set top box, security system control box, personal computer, or other home electronic device) may be used to provide the user with a hint in the form of a an estimated position (e.g., direction and/or distance) of the electronic label from the monitoring device. The estimated position information, in some implementations, may be supplied to the user, for example using an audible message (e.g., “northwest by seven feet”) and/or a graphical indication (e.g., mapped position estimate, compass heading, text message, etc.).

In some implementations, a tracking interface may be presented to a user (634). The tracking interface, in some implementations, may include a compass readout or a radial graph indicating an estimated direction of the electronic label from the monitoring device. In some implementations, the tracking interface may include an estimated distance of the electronic label from the monitoring device.

While the user attempts to locate the misplaced item having the electronic label (636), in some implementations, the estimated position of the electronic label may be periodically updated (632) and presented to the user (634). For example, if the monitoring device is a portable device, the user may carry the monitoring device while attempting to locate the misplaced item. While the user is moving through the area with the monitoring device, in some implementations, the monitoring device may recalculate a current estimated position of the electronic label (632) in relation to the monitoring device and update this current estimated position in the tracking interface presented to the user (634).

If the user locates the misplaced item (636), in some implementations, the tracking interface may be closed (638). In some implementations, the user may be prompted to confirm identification of the position of the misplaced item. In some implementations, a control within the tracking interface, upon selection, may cause the tracking interface to close. If the monitoring device is a portable device, in some implementations, upon determining that the electronic label associated with the misplaced item is within a threshold distance of the monitoring device (e.g., approximately twelve inches, three feet, etc.), the tracking feature may assume the item to be “found” (636) and automatically close the tracking interface (638). Once the tracking interface has been closed (638), in some implementations, the transmission from the paired label may continue to be monitored (620).

Although described in a particular series of events, in other implementations, the individual steps of the method 600 may be accomplished in a different order, and one or more steps may be added or removed. In some implementations, for example, a tracking range may be determined for the electronic label (616) prior to alert information being entered for the electronic label (614). In another example, in some implementations, rather than entering alert information for the electronic label (614) and determining a tracking range for the electronic label (616), the newly paired electronic label may be added to a group sharing a preexisting alert and tracking profile. Other modifications are possible without straying from the spirit and scope of the method 600.

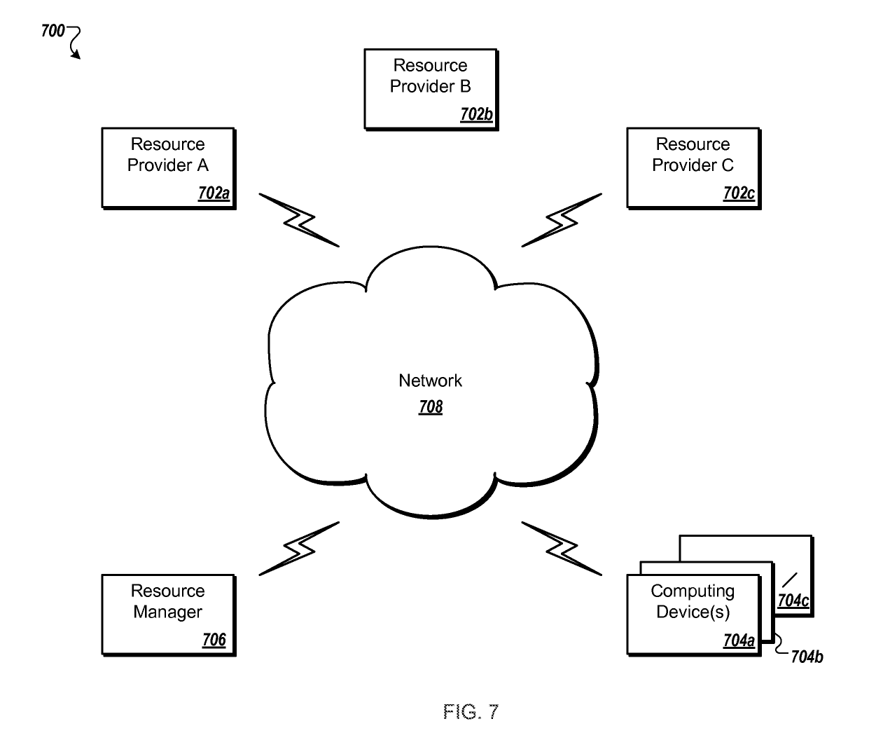

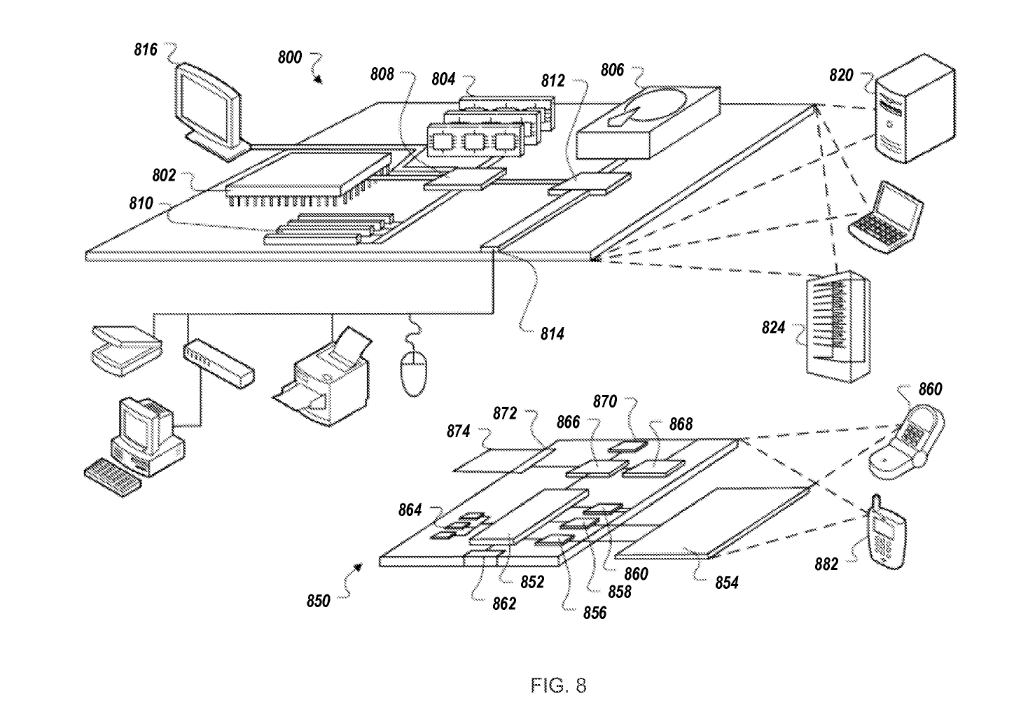

As shown in FIG. 7, an implementation of an exemplary cloud computing environment 700 for localized tracking of electronically labeled items is shown and described. In brief overview, the cloud computing environment 700 may include one or more resource providers 702a, 702b, 702c (collectively, 702). Each resource provider 702 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 702 may be connected to any other resource provider 702 in the cloud computing environment 700. In some implementations, the resource providers 702 may be connected over a computer network 708. Each resource provider 702 may be connected to one or more computing device 704a, 704b, 704c (collectively, 704), over the computer network 708.

The cloud computing environment 700 may include a resource manager 706. The resource manager 706 may be connected to the resource providers 702 and the computing devices 704 over the computer network 708. In some implementations, the resource manager 706 may facilitate the provision of computing resources by one or more resource providers 702 to one or more computing devices 704. The resource manager 706 may receive a request for a computing resource from a particular computing device 704. The resource manager 706 may identify one or more resource providers 702 capable of providing the computing resource requested by the computing device 704. The resource manager 706 may select a resource provider 702 to provide the computing resource. The resource manager 706 may facilitate a connection between the resource provider 702 and a particular computing device 704. In some implementations, the resource manager 706 may establish a connection between a particular resource provider 702 and a particular computing device 704. In some implementations, the resource manager 706 may redirect a particular computing device 704 to a particular resource provider 702 with the requested computing resource.

FIG. 8 shows an example of a computing device 800 and a mobile computing device 850 that can be used to implement the techniques described in this disclosure. The computing device 800 is intended to represent various forms of digital computers, such as laptops, desktops, workstations, personal digital assistants, servers, blade servers, mainframes, and other appropriate computers. The mobile computing device 850 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 800 includes a processor 802, a memory 804, a storage device 806, a high-speed interface 808 connecting to the memory 804 and multiple high-speed expansion ports 810, and a low-speed interface 812 connecting to a low-speed expansion port 814 and the storage device 806. Each of the processor 802, the memory 804, the storage device 806, the high-speed interface 808, the high-speed expansion ports 810, and the low-speed interface 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as a display 816 coupled to the high-speed interface 808. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 804 stores information within the computing device 800. In some implementations, the memory 804 is a volatile memory unit or units. In some implementations, the memory 804 is a non-volatile memory unit or units. The memory 804 may also be another form of computer-readable medium, such as a magnetic or optical disk.

The storage device 806 is capable of providing mass storage for the computing device 800. In some implementations, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 802), perform one or more methods, such as those described above. The instructions can also be stored by one or more storage devices such as computer- or machine-readable mediums (for example, the memory 804, the storage device 806, or memory on the processor 802).

The high-speed interface 808 manages bandwidth-intensive operations for the computing device 800, while the low-speed interface 812 manages lower bandwidth-intensive operations. Such allocation of functions is an example only. In some implementations, the high-speed interface 808 is coupled to the memory 804, the display 816 (e.g., through a graphics processor or accelerator), and to the high-speed expansion ports 810, which may accept various expansion cards (not shown). In the implementation, the low-speed interface 812 is coupled to the storage device 806 and the low-speed expansion port 814. The low-speed expansion port 814, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. In addition, it may be implemented in a personal computer such as a laptop computer 822. It may also be implemented as part of a rack server system 824. Alternatively, components from the computing device 800 may be combined with other components in a mobile device (not shown), such as a mobile computing device 850. Each of such devices may contain one or more of the computing device 800 and the mobile computing device 850, and an entire system may be made up of multiple computing devices communicating with each other.

The mobile computing device 850 includes a processor 852, a memory 864, an input/output device such as a display 854, a communication interface 866, and a transceiver 868, among other components. The mobile computing device 850 may also be provided with a storage device, such as a micro-drive or other device, to provide additional storage. Each of the processor 852, the memory 864, the display 854, the communication interface 866, and the transceiver 868, are interconnected using various buses, and several of the components may be mounted on a common motherboard or in other manners as appropriate.

The processor 852 can execute instructions within the mobile computing device 850, including instructions stored in the memory 864. The processor 852 may be implemented as a chipset of chips that include separate and multiple analog and digital processors. The processor 852 may provide, for example, for coordination of the other components of the mobile computing device 850, such as control of user interfaces, applications run by the mobile computing device 850, and wireless communication by the mobile computing device 850.

The processor 852 may communicate with a user through a control interface 858 and a display interface 856 coupled to the display 854. The display 854 may be, for example, a TFT (Thin-Film-Transistor Liquid Crystal Display) display or an OLED (Organic Light Emitting Diode) display, or other appropriate display technology. The display interface 856 may include appropriate circuitry for driving the display 854 to present graphical and other information to a user. The control interface 858 may receive commands from a user and convert them for submission to the processor 852. In addition, an external interface 862 may provide communication with the processor 852, so as to enable near area communication of the mobile computing device 850 with other devices. The external interface 862 may provide, for example, for wired communication in some implementations, or for wireless communication in other implementations, and multiple interfaces may also be used.

The memory 864 stores information within the mobile computing device 850. The memory 864 can be implemented as one or more of a computer-readable medium or media, a volatile memory unit or units, or a non-volatile memory unit or units. An expansion memory 874 may also be provided and connected to the mobile computing device 850 through an expansion interface 872, which may include, for example, a SIMM (Single In Line Memory Module) card interface. The expansion memory 874 may provide extra storage space for the mobile computing device 850, or may also store applications or other information for the mobile computing device 850. Specifically, the expansion memory 874 may include instructions to carry out or supplement the processes described above, and may include secure information also. Thus, for example, the expansion memory 874 may be provide as a security module for the mobile computing device 850, and may be programmed with instructions that permit secure use of the mobile computing device 850. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 852), perform one or more methods, such as those described above. The instructions can also be stored by one or more storage devices, such as one or more computer- or machine-readable mediums (for example, the memory 864, the expansion memory 874, or memory on the processor 852). In some implementations, the instructions can be received in a propagated signal, for example, over the transceiver 868 or the external interface 862.

The mobile computing device 850 may communicate wirelessly through the communication interface 866, which may include digital signal processing circuitry where necessary. The communication interface 866 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 868 using a radio-frequency. In addition, short-range communication may occur, such as using a Bluetooth, WiFi, or other such transceiver (not shown). In addition, a GPS (Global Positioning System) receiver module 870 may provide additional navigation- and location-related wireless data to the mobile computing device 850, which may be used as appropriate by applications running on the mobile computing device 850.

The mobile computing device 850 may also communicate audibly using an audio codec 860, which may receive spoken information from a user and convert it to usable digital information. The audio codec 860 may likewise generate audible sound for a user, such as through a speaker, e.g., in a handset of the mobile computing device 850. Such sound may include sound from voice telephone calls, may include recorded sound (e.g., voice messages, music files, etc.) and may also include sound generated by applications operating on the mobile computing device 850.

The mobile computing device 850 may be implemented in a number of different forms, as shown in the figure. For example, it may be implemented as a cellular telephone 880. It may also be implemented as part of a smart-phone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, a system for localized tracking of items with electronic labels is provided. Having described certain implementations of methods and systems for pairing an electronic label with a tracking application and tracking an item having the electronic label, it will now become apparent to one of skill in the art that other implementations incorporating the concepts of the disclosure may be used. Therefore, the disclosure should not be limited to certain implementations, but rather should be limited only by the spirit and scope of the following claims.

1. A method comprising:
identifying, by a monitoring device, a transmission signal of an electronic label, wherein the monitoring device comprises an antenna and a processor;
determining a distance for monitoring the transmission signal of the electronic label;
calibrating a transmission strength for communication with the electronic label via the transmission signal, wherein the transmission strength is calibrated to approximately achieve the distance;
configuring a communication link between the antenna and the electronic label at approximately the transmission strength;
monitoring availability of the communication link;
identifying a loss of connection with the communication link; and
responsive to the loss of connection, causing, by the monitoring device, an alert to be issued.

2. The method of claim 1, wherein the transmission signal comprises a short-range transmission signal.

3. (canceled)

4. The method of claim 1, wherein calibrating the transmission strength includes energizing the electronic label, through the antenna, at a first energy level.

5. The method of claim 1, further comprising storing, on a memory, information associated with the electronic label.

6. The method of claim 5, wherein the information comprises signal-identifying information.

7. (canceled)

8. The method of claim 5, wherein the information comprises the distance.

9. (canceled)

10. The method of claim 5, wherein the monitoring device is configured to access the memory via a network connection.

11. (canceled)

12. The method of claim 1, wherein the electronic label comprises a radio frequency (RF) antenna.

13. The method of claim 12, wherein the RF antenna is designed to modulate an interrogating signal of the monitoring device to produce a backscatter signal.

14. An apparatus comprising:
an antenna;
a processor; and
memory, the memory storing instructions that, when executed, cause the processor to:
determine a transmission strength for communication with an electronic label at least up to a range,
establish a communication signal with the electronic label,
monitor availability of a transmission from the electronic label, and
identify a failure to detect the transmission.

15. The apparatus of claim 14, wherein:
the instructions further cause the processor to, prior to establishing the communication signal, energize, by the antenna, a passive transmitter of the electronic label; and
the transmission is a reflected transmission of an interrogating signal emitted from the antenna.

16. (canceled)

17. (canceled)

18. The apparatus of claim 14, wherein the instructions further cause the processor to store, in a second memory, information associated with the electronic label.

19. (canceled)

20. The apparatus of claim 18, wherein the instructions further cause the processor to, upon re-establishment of power following a power loss:
access a portion of the information, wherein the portion is useful for detection of the reflected transmission;
identify availability of the reflected transmission; and
return to monitoring availability of the reflected transmission.

21. The apparatus of claim 14, wherein the instructions further cause the processor to authenticate the electronic label prior to monitoring availability of the reflected transmission.

22. The apparatus of claim 21, wherein
authenticating the electronic label comprises reading an electronically-readable code on the electronic label; and
the instructions further cause the processor to compare data derived from the electronically-readable code to authentication data stored in the memory.

23. A non-transitory computer readable medium, wherein the computer readable medium stores instructions that, when executed by a processor, cause the processor to:
receive a pairing request via a user interface;
determine an energy level correlating to a range of transmission, wherein
the energy level, when applied to a passive radio frequency tag, is configured enable the passive radio frequency tag to reflect an interrogating signal from a monitoring antenna as a reflected signal, and
the reflected signal is configured to be detectable by the monitoring antenna up to and including the range of transmission;
energize the passive radio frequency tag at approximately the determined energy level; and
monitor availability of the reflected signal.

24. The non-transitory computer readable medium of claim 23, wherein the instructions further cause the processor to receive the range of transmission via the user interface.

25. The non-transitory computer readable medium of claim 23, wherein the instructions further cause the processor to trigger an alert mechanism responsive to loss of availability of the reflected signal.

26. The non-transitory computer readable medium of claim 23, wherein the instructions further cause the processor to:
receive a tracking request via the user interface; and
estimate a distance between the monitoring antenna and the passive radio frequency tag.

27. The non-transitory computer readable medium of claim 23, wherein the instructions further cause the processor to:
receive a tracking request via the user interface; and
estimate a direction of the passive radio frequency tag from the monitoring antenna.

28.-38. (canceled)
